(19) United States
(12) Patent Application Publication
(10) Pub. No.: US 2017/0134699 A1
(43) Pub. Date: May 11, 2017

(54) METHOD AND APPARATUS FOR PHOTOGRAPHING USING ELECTRONIC DEVICE CAPABLE OF FLYING

(71) Applicant: Samsung Electronics Co., Ltd., Gyeonggi-do (KR)

(72) Inventors: Minyoung KIM, Gyeonggi-do (KR); Seung-Nyun KIM, Incheon (KR); So-Young LEE, Gyeonggi-do (KR)

(21) Appl. No.: 15/271,536

(22) Filed: Sep. 21, 2016

(30) Foreign Application Priority Data
Nov. 11, 2015 (KR) 10-2015-0158114

(51) Int. Cl. H04N 7/18; G08B 5/38

(52) U.S. Cl. CPC H04N 7/183; G08B 5/38

(57) ABSTRACT

An electronic device and flying device and respective methods are disclosed. The electronic device includes a communication circuit, a position notification device, one or more sensors, a processor which executes the method, including transmitting a first signal to the flying device to recognize an image signal generated by the electronic device, generating the image signal, receiving a second signal indicating that the flying device recognized the image signal, and transmitting a third signal to control movement of the flying device. The flying device includes a camera, a communication circuit, one or more sensors, a processor which executes a method, including receiving a first signal from the electronic device, controlling the camera to detect an image signal generated by the electronic device for determining a position of the electronic device, and controlling movement of the flying device based on a second signal and the determined position of the electronic device.

### CLAIM OF PRIORITY

This application claims the priority under 35 U.S.C. §119(a) to Korean Application Serial No. 10-2015-0158114, which was filed in the Korean Intellectual Property Office on Nov. 11, 2015, the entire content of which is hereby incorporated by reference.

### TECHNICAL FIELD

Various embodiments of the present disclosure relate to a method to provide a photographing function by using an electronic device that is able to fly, and to an apparatus thereof.

### BACKGROUND

Recently, electronic devices that can fly and photograph images have been developed. Initially, such electronic devices were used for professional applications, such as image photographing for broadcast. However, these flying electronic devices are increasingly operated for personal usage after increasing reductions in size and manufacturing cost. In general, these devices may take the form of unmanned aerial vehicles (UAV) or helicopter-shaped devices, which can fly and can be controlled via the induction of radio waves, and sometimes referred to as drones.

The drone may include a camera in order to provide a picture/moving image photographing function. Typically, users manually control movement of the drone to a desired place for photographing pictures/moving images through a controller (e.g., a remote control or “RC”) or an external electronic device (e.g., a smart phone), and then perform the picture/moving image photographing.

### SUMMARY

In general, in order to photograph images by using the drone, the drone is moved to a desired position by controlling the same, so manipulating the drone is inconvenient. For example, since the drone control method of using a drone controller utilizes simultaneously control for movement in at least four directions, controlling the drone is not easy unless it is controlled by a user who is familiar with the drone. In the case of a drone that interworks with a smart phone to support the photographing, the user may perform the picture/moving image photographing while viewing, through a display of the smart phone, preview images that are received from a camera of the drone. However, it may be very difficult to accurately control the photographing while operating the drone unless it is conducted by a highly experienced user.

Various embodiments may disclose a method and an apparatus for controlling an electronic device that is able to fly (hereinafter, a flying device) by using an electronic device and controlling the picture/moving image photographing by the flying device.

Various embodiments may provide a method and an apparatus for controlling, through an electronic device of the user, the image/moving image photographing by the flying device and the movement of the flying device therefor.

Various embodiments may provide an apparatus and a method in which the photographing operation can be controlled by allowing the movement (e.g., position translation, hovering, rotation of the flying device, revolution of the flying device, or the like) of the flying device (e.g., the drone) for the photographing of a camera to interwork with an electronic device of the user.

Various embodiments may provide a photographing method and an apparatus for supporting the photographing desired by the user by using an electronic device that is capable of flying based on the position of the electronic device when photographing pictures/moving images by using a camera that is mounted on the electronic device that is capable of flying.

In various embodiment of the present disclosure, an electronic device includes a communication circuit configured to communicatively couple with a flying device including a camera device, a position notification device for generating an image signal, one or more sensors configured to detect a motion of the electronic device, a processor electrically coupled with the communication circuit, the position notification device, and the one or more sensors, and a memory electrically coupled with the processor, the memory storing instructions that, when executed, cause the processor to: transmit, using the communication circuit, a first signal to the flying device instructing the flying device to recognize the generated image signal, generate the image signal via the position notification device, receive, using the communication circuit, a second signal from the flying device confirming that the flying device recognized the generated image signal, and transmit, using at least one of the communication circuit and the position notification device, a third signal to the flying device to control movement of the flying device.

In various embodiments of the present disclosure, a flying device includes a camera device, a communication circuit configured to communicate with an electronic device, one or more sensors configured to detect movement of the flying device, a processor electrically coupled with the camera device, the communication circuit, and the one or more sensors, and a memory electrically coupled with the processor, the memory storing instructions that, when executed, cause the processor to: in response to receiving a first signal from the electronic device using the communication circuit, control the operation of the flying device according to the first signal and control the camera device to detect an image signal generated by the electronic device, determine a position of the electronic device based on the detected image signal, and in response to receiving, using the communication circuit, a second signal from the electronic device, control movement of the flying device based on at least a portion of the received second signal and the determined position of the electronic device.

In various embodiments of the present disclosure, an operating method of an electronic device includes transmitting a first signal to a flying device instructing the flying device to recognize an image signal generated by the electronic device, generating the image signal, receiving a second signal from the flying device indicating that the flying device recognized the image signal generated by the electronic device based on at least a portion of the image signal; and transmitting a third signal to the flying device to control movement of the flying device.

In various embodiments of the present disclosure, an operating method of a flying device includes receiving a first signal transmitted from an electronic device, controlling operations of the flying device in response to the received first signal, controlling a camera device to detect an image signal generated by the electronic device and determining a position of the electronic device based on the detected image signal, and in response to receiving a second signal controlling movement of the flying device based on at least a portion of the received second signal and the determined position of the electronic device.

Various embodiments of the present disclosure may provide a computer-readable recording medium that stores a program for executing the method in the processor.

### BRIEF DESCRIPTION OF THE DRAWINGS

The above and other aspects and features of the present disclosure will be more apparent from the following detailed description taken in conjunction with the accompanying drawings, in which:

FIG. 1 is a diagram illustrating a network environment that includes an electronic device, according to various embodiments;

FIG. 2 is a block diagram of an electronic device, according to various embodiments;

FIG. 3 is a block diagram of a program module, according to various embodiments;

FIG. 4, FIG. 5, FIG. 6 and FIG. 7 are views to explain a system and its operation, according to various embodiments of the present disclosure;

FIG. 8 is a block diagram schematically showing the configuration of an electronic device, according to various embodiments of the present disclosure;

FIG. 9 is a block diagram schematically showing the configuration of a flying device, according to various embodiments of the present disclosure;

FIG. 10 is a view to explain the operation between the electronic device and the flying device in the system, according to the embodiment of the present disclosure;

FIG. 11, FIG. 12 and FIG. 13 are views illustrating an example of generating a position notification signal in the electronic device, according to the embodiment of the present disclosure;

FIG. 14 is a flowchart to explain the operation of the electronic device, according to various embodiments of the present disclosure;

FIG. 15A and FIG. 15B are flowcharts illustrating an operating method of the flying device, according to various embodiments of the present disclosure;

FIG. 16 is a view illustrating an operation example for controlling the flying device in the electronic device, according to various embodiments of the present disclosure; and

FIG. 17 is a view illustrating a diagram showing an operation example for configuring a photographing composition in the electronic device, according to various embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

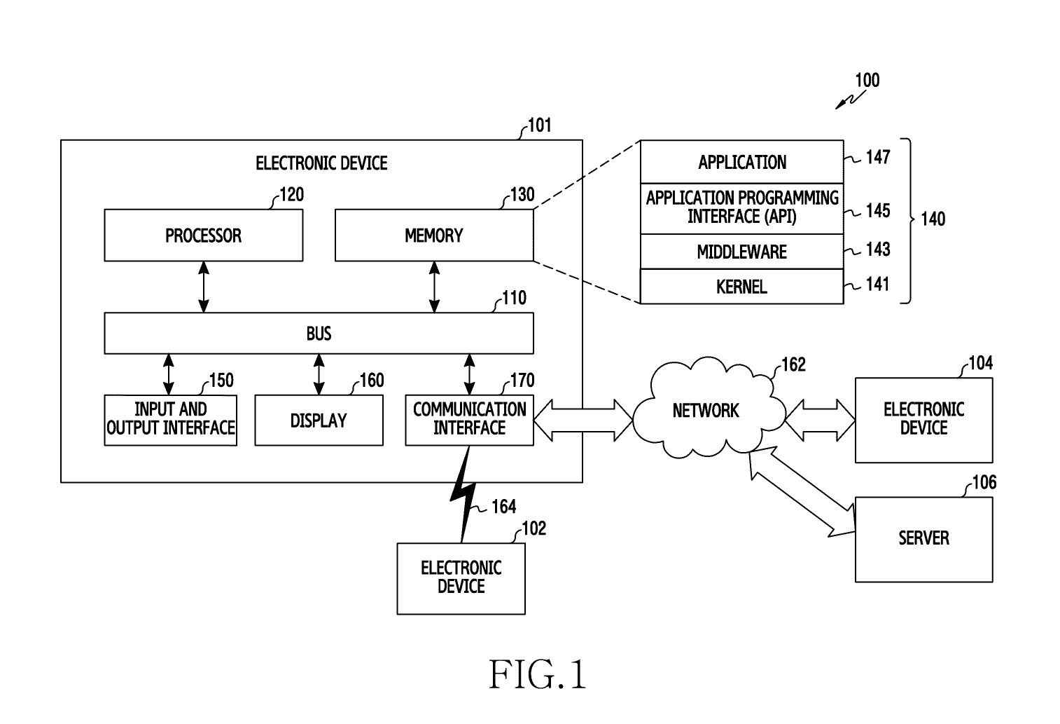

FIG. 1 illustrates a network environment including an electronic device according to various embodiments of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a Central Processing Unit (CPU), an Application Processor (AP), and a Communication Processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106).The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short-range communication 164. The short-range communication 164 may include at least one of, for example, Wi-Fi, Bluetooth, Near Field Communication (NFC), and Global Navigation Satellite System (GNSS). GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers.

According to various embodiments of the present disclosure, all or some of the operations performed in the electronic device 101 may be executed in another electronic device or a plurality of electronic devices (e.g., the electronic devices 102 and104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

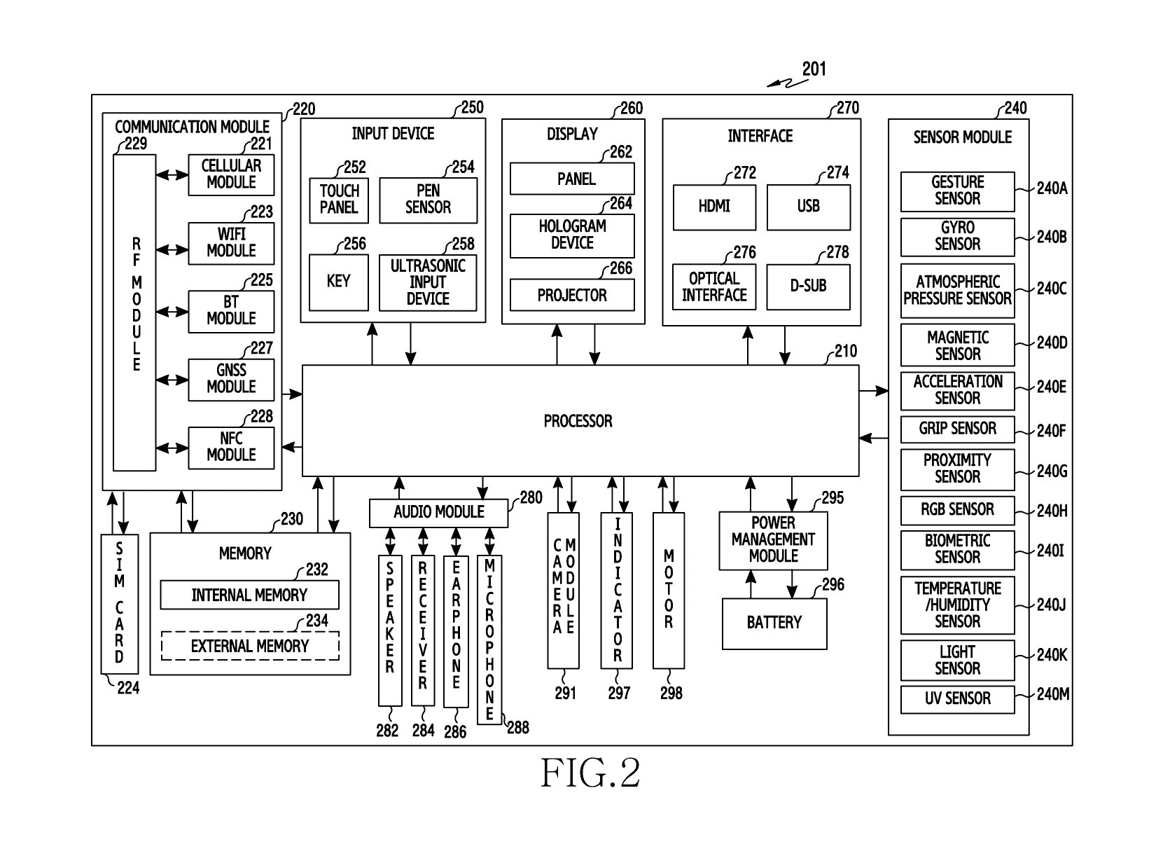

FIG. 2 is a block diagram of an electronic device according to various embodiments of the present disclosure.

The electronic device 201 may include, for example, all or a part of the electronic device 101 shown in FIG. 1. The electronic device 201 may include one or more processors 210 (e.g., Application Processors (AP)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using the subscriber identification module 224 (for example, the SIM card). According to an embodiment of the present disclosure, the cellular module 221 may perform at least some of the functions that the processor 210 may provide. According to an embodiment of the present disclosure, the cellular module 221 may include a communication processor (CP).

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue or “RGB” sensor), a biometric sensor (medical sensor) 2401, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

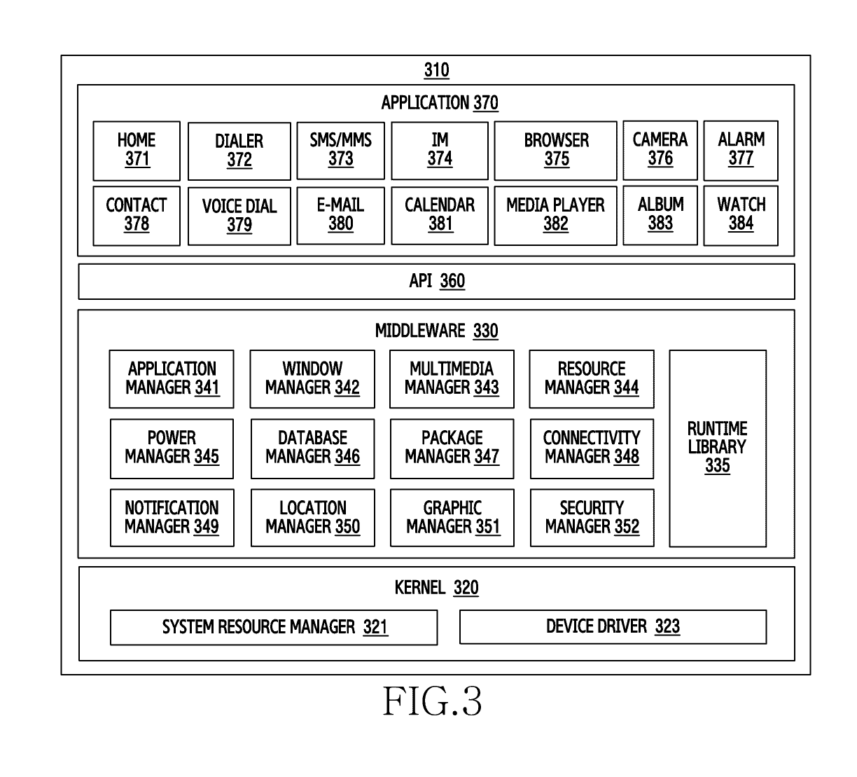

FIG. 3 is a block diagram of a program module according to various embodiments of the present disclosure.

According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android, iOS, Windows, Symbian, Tizen, Bada, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function utilized in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed.

The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format utilized for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like utilized for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device.

The graphic manager 351 may manage a graphic effect which will be provided to a user, or a user interface related to the graphic effect. The security manager 352 may provide all security functions utilized for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock (or watch) 384, health care (e.g., measuring exercise quantity or blood sugar), or environment information (e.g., providing atmospheric pressure, humidity, or temperature information).

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 1410). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or programming modules according to various embodiments of the present disclosure may include at least one of the above described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added.

Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

Proposed various embodiments of the present disclosure disclose a method and an apparatus for controlling an electronic device that is capable of flying by using an electronic device and for controlling the picture/moving image photographing by the electronic device that is capable of flying. In various embodiments, the electronic device that is capable of flying may include a camera module in order to thereby provide a picture/moving image photographing function. In the following description according to various embodiments, the electronic device that is capable of flying may be referred to as a flying device or a drone.

The electronic device, according to various embodiments of the present disclosure, may support a communication function and a photographing function, and may include all devices that use one or more of various processors, such as an AP (application processor), a CP (communication processor), a GPU (graphic processing unit), or a CPU (central processing unit). For example, the electronic device, according to various embodiments, may include all information communication devices, multimedia devices, smart phones, wearable devices, and IoT (Internet of things) devices, which include a battery and support a communication function and a photographing function, or may include application devices thereof.

The flying device (or the drone), according to various embodiments of the present disclosure, may include all devices that can fly and support a communication function and a photographing function, and that uses one or more of various processors, such as an AP, a GPU, or a CPU.

Hereinafter, an operating method and an apparatus, according to various embodiments of the present disclosure, will be described with reference to the accompanying drawings. However, since the various embodiments are not restricted or limited by the following description, it should be noted that applications can be made to the various embodiments based on embodiments that will be described below. Hereinafter, various embodiments of the present disclosure will be described based on an approach of hardware. However, various embodiments of the present disclosure include a technology that uses both hardware and software and thus, the various embodiments of the present disclosure may not exclude the perspective of software.

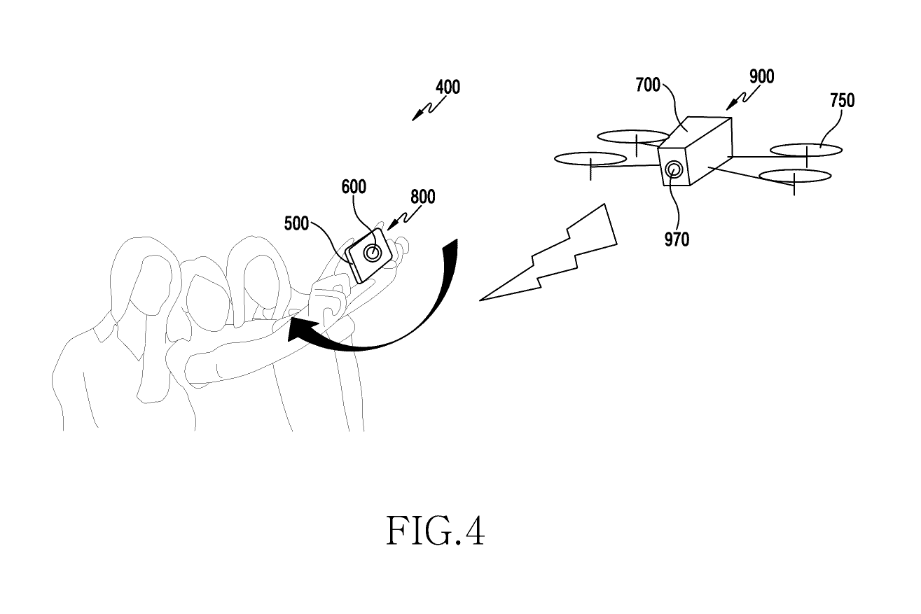

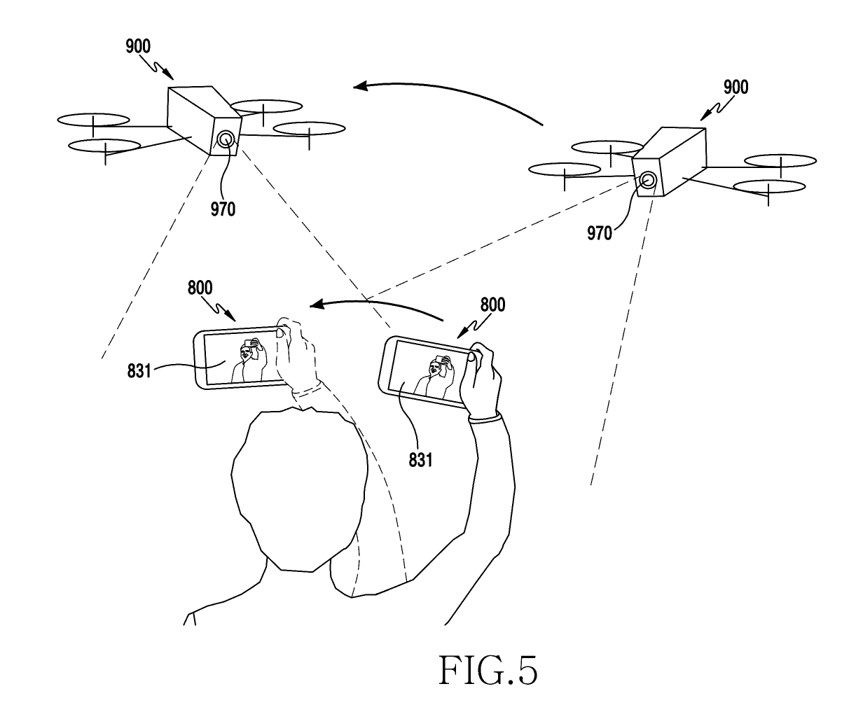

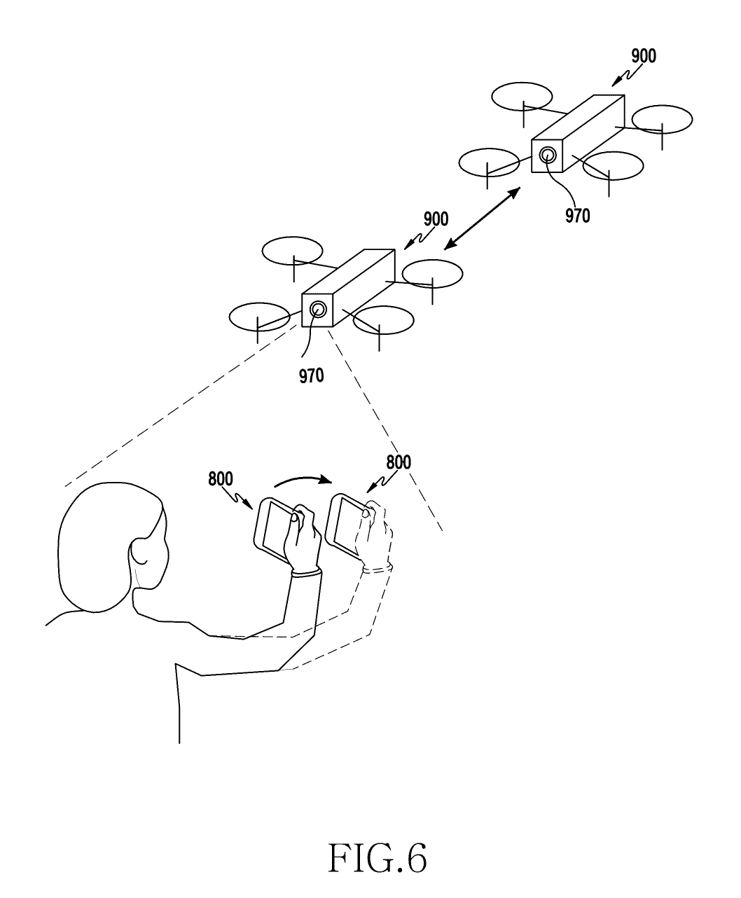

FIGS. 4 to 7 are views to explain a system and its operation, according to various embodiments of the present disclosure.

Referring to FIGS. 4 to 7, a system 400, according to various embodiments of the present disclosure, may be configured to include an electronic device 800 and a flying device 900.

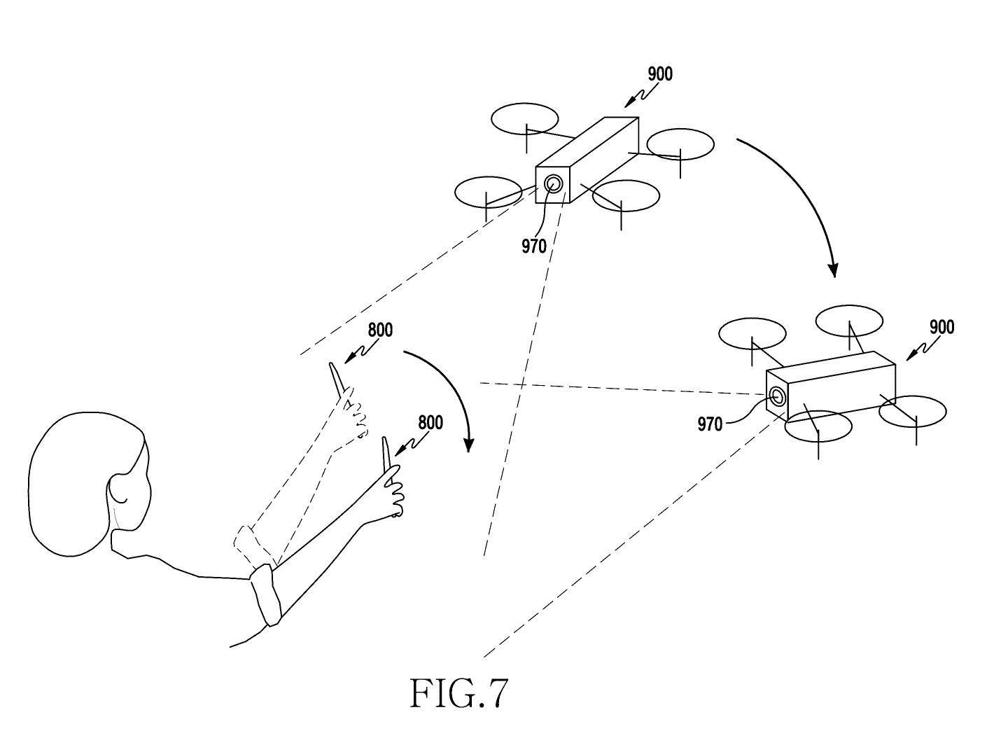

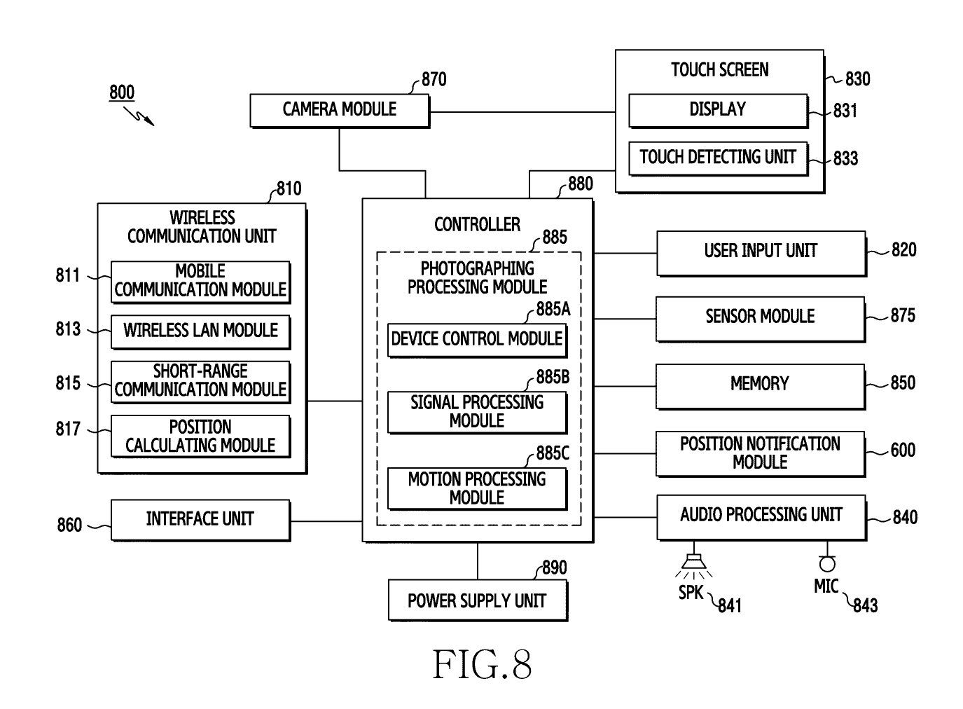

In various embodiments, the electronic device 800 may be configured to include a housing 500 (or a body) and additional devices that are provided inside, or outside, the housing 500 in order to thereby execute functions of the electronic device 800. In various embodiments, the additional devices may include a position notification module 600, a sensor module (not shown), a display (element 831 of FIG. 8), a camera module (element 870 of FIG. 8), or the like. In various embodiments, the additional devices may further include a speaker (not shown), a microphone (not shown), a communication interface (e.g., not shown, but may include charging or data input/output ports, audio input/output ports, or the like), or buttons (not shown). In various embodiments, the an electronic device 800may be carried and used by the user, including devices such as a smart phone, a tablet PC, or sub devices (e.g., wearable devices or accessory devices). These will be used as typical examples of the electronic device 800.

In various embodiments, the position notification module 600 may include a device for providing (or outputting) a configured notification for the flying device 900 to identify the position of the electronic device 800, or to correct the photographing position thereof. According to various embodiments, the position notification module 600 may include a flash LED that is provided on the back side of the electronic device 800. According to various embodiments, the position notification module 600 may be implemented to include at least some sensor of a sensor module (not shown), such as an HRM sensor.

In various embodiments, when the electronic device 800 is operatively or communicatively connected or couple with the flying device 900, the electronic device 800 may process an operation related to the picture/moving image photographing by using the flying device 900. According to an embodiment, the electronic device 800, for example, may process an operation related to the user's control for the photographing of a desired composition through the flying device 900. In various embodiments, the examples of the operation of the electronic device 800 will be described with reference to the drawings illustrated below.

In various embodiments, the flying device 900 may be configured to include a housing 700 (or a body) and additional devices may be provided inside or outside the housing 700 in order to execute functions of the flying device 900. In various embodiments, the additional devices may include a camera module 970, a sensor module (not shown), a propeller 750, a motor (e.g., the motor 298 of FIG. 2), and the like. In various embodiments, the flying device 900 may be wirelessly connected to the electronic device 800 in order to receive a variety of information (such as, for example, control signals, position identification signals, etc.), which is transmitted from the electronic device 800, with which it may perform a moving and photographing operation based on the received information.

According to various embodiments, the flying device 900 may operate in response to the operation initiation control or command of the electronic device 800, and may move to a photographing position based on an output of the position notification module 600 of the electronic device 800 to then be stationed. According to an embodiment, the flying device 900 may operate the provided propeller 750 in response to the operation initiation control of the electronic device 800 in order to move to a position (such as, for example, a photographing position or a target point), in which the output of the position notification module 600 of the electronic device 800 can be recognized, to then be stationed. In various embodiments, the operation of the flying device 900 (such as, for example, the operation of a flying power unit or propeller 750 of the flying device 900) may be conducted in various manners. According to an embodiment, the flying device 900 may be activated based on a wireless signal received from the electronic device 800, which is wirelessly connected with the flying device 900. Alternatively, the flying device 900 may be activated based on sensor information that is received from the sensor module of the flying device 900. The flying device 900 may detect a current that is generated from a motor (e.g., the motor 298 of FIG. 2) for driving the propeller 750 in order to thereby operate the propeller 750 of the flying device 900.

According to various embodiments, the electronic device 800 may communicate (for example, may be paired) with the flying device 900 by wireless communication (e.g., RF, BT, BLE, WiFi, or the like). The user may variously change the configuration/operation state of the flying device 900 through the electronic device 800. For example, the flying device 900 may not have a separate display, and may be configured with a limited input unit (buttons). According to various embodiments, when the flying device 900 is controlled in with the electronic device 800, various user interfaces may be provided to the user through the electronic device 800, and the user may control the configuration/operation of the flying device 900 according to the provided user interfaces.

As shown in FIGS. 4 to 7, when the electronic device 800 detects the initiation of (e.g., entry into) a photographing mode (e.g., a selfie photographing mode) while operatively connected with the flying device 900 in wireless communication (e.g., BT, BLE, WiFi, RF, etc.), the electronic device 800 may transmit to the flying device 900 a control signal for driving the flying device 900. When the electronic device 800 detects the initiation of the photographing mode, the electronic device 800 may control the output by the position notification module 600.

The flying device 900 may operate in response to the control signal of the electronic device 800. For example, the flying electronic device 800 may drive the motor (e.g., the motor 298 of FIG. 2) according to the control signal of the electronic device 800 in order to induce operation of the propeller 750 and initiate hovering. The flying device 900 may turn on the camera module 970 when initiating the operation.

The flying device 900 may perform a search operation for recognizing the position of the electronic device 800 (or a photographing position or a target point) after hovering. According to various embodiments, after hovering, the flying device 900 may search for a signal by the position notification module 600 of the electronic device 800 by rotating (e.g., rotating clockwise or counterclockwise) about a fixed rotational axis of the flying device 900 (e.g., the center point of the flying device 900). According to an embodiment, the flying device 900 may search for a signal (e.g., an LED flashing signal, an HRM sensor flashing signal, or a QR code) output from the position notification module 600 of the electronic device 800 in order to thereby recognize the position of the electronic device 800 (or the user).

The flying device 900 may transmit, to the electronic device 800, an image (e.g., a preview image) obtained through the camera module 970. The electronic device 800 may receive the image transmitted from the flying device 900 after entering the photographing mode, and may output the received image as a preview through the display 831.

In various embodiments, the user may control the motion of the electronic device 800 in order to move the flying device 900 to a position desired by the user, and in order to perform the photographing at the time desired by the user. For example, as shown in FIG. 5, the user may control leftwards and rightwards horizontal movement of the flying device 900 relative to the user by moving the electronic device 800 left and right. Alternatively, as shown in FIG. 6, the user may control the forward and backward movement of the flying device 900 relative to the user by moving the electronic device 800 forward and backwards relative to the flying device 900. Alternatively, as shown in FIG. 7, the user may control the vertical movement of the flying device 900 by moving the electronic device 800 vertically up and down. According to various embodiments, it is possible to control the height (throttle), the rotation (yaw), or the horizontal translation (pitch and roll) of the flying device 900 by the motion of the electronic device 800, and thus the user may configure the photographing composition based on motions executed using the electronic device 800.

According to various embodiments, the electronic device 800 may detect a motion in the photographing mode based on a variety of sensors (e.g., an acceleration sensor, a gyro sensor, an angular velocity sensor, a rotation recognition sensor, or the like). When the electronic device 800 detects a motion, the electronic device 800 may create motion data (for example, including a movement coordinate value as movement control information) corresponding to the motion, and may transmit the same to the flying device 900. In various embodiments, the motion data may contain control signals for controlling the height (throttle), the rotation (yaw), or the horizontal translation (pitch and roll) of the flying device 900. When the motion data is received from the electronic device 800, the flying device 900 may move to a position corresponding to the motion data. The flying device 900 may continue to trace the output signal of the position notification module 600 of the electronic device 800 during the movement, and may correct the photographing position based on the output signal of the position notification module 600. For example, the flying device 900 may move (fly) to the photographing position desired by the user by using an anchor point where the output signal of the position notification module 600 of the electronic device 800 is recognized and by using the motion data received from the electronic device 800.

The user may position the flying device 900 in a desired composition in order to thereby perform the photographing as shown in FIG. 5, 6, or 7. For example, the user may select a photographing button of the electronic device 800, and then may let the electronic device 800 down.

When the electronic device 800 detects an input signal by the photographing button, the electronic device 800 may transmit a photographing signal to the flying device 900. The flying device 900 may perform the photographing in response to the photographing signal from the electronic device 800. According to various embodiments, when the photographing signal is received, the flying device 900 may automatically perform the photographing after waiting for a predetermined time (for example, 3 seconds or 5 seconds), or may automatically perform the photographing when detecting that the electronic device 800 disappears from the view point after the reception of the photographing signal. The flying device 900 may transmit photographed data to the electronic device 800. When the photographed data is received from the flying device 900, the electronic device 800 may selectively output the received photographed data through the display 831, and may store the same in a memory.

As described above, in various embodiments of the present disclosure, the movement {for example, position translation, hovering, rotation of the flying device 900, revolution of the flying device 900, or the like) of the flying device 900, which includes the camera module 970, may be controlled by the motion of the electronic device 800, and the position thereof may be corrected (controlled) through the position notification module 600 in order to configure an accurate photographing position. Therefore, the user may easily control the photographing by using the flying device 900 through the motion of raising the electronic device 800 forward as if the user performs the selfie by using the electronic device 800.

The control operation of the electronic device 800 and the flying device 900, and the control operation of the photographing, according to various embodiments, will be described in detail with reference to the drawings illustrated below.

FIG. 8 is a block diagram schematically showing the configuration of an electronic device, according to various embodiments of the present disclosure.

Referring to FIG. 8, the electronic device 800, according to various embodiments of the present disclosure, may include, for example, a wireless communication unit 810, a user input unit 820, a touch screen 830, an audio processing unit 840, a memory 850, an interface unit 860, a camera module 870, a controller 880 (e.g., the processor 120), a position notification module 600, and a power supply unit 890. In various embodiments of the present disclosure, the elements shown in FIG. 8 are not essential, so the electronic device 800 may be implemented to have more, or fewer, elements, than the elements shown in FIG. 8.

The wireless communication unit 810, for example, may have the same, or a similar, configuration as the communication module 220 of FIG. 2. The wireless communication unit 810 may include one or more modules that enable wireless communication between the electronic device 800 and external electronic devices (e.g., the flying device 900, other electronic devices 102 and 104, or the server 106). For example, the wireless communication unit 810 may be configured to include a mobile communication module 811, a wireless local area network (WLAN) module 813, a short-range communication module 815, and a position calculating module 817. In various embodiments, the wireless communication unit 810 may include a module (e.g., a short-range communication module, a telecommunication module, or the like) for performing communication with the external electronic devices around the wireless communication unit 810.

The mobile communication module 811, for example, may have the same, or a similar, configuration as the cellular module 221 of FIG. 2. The mobile communication module 811 may transmit/receive wireless signals to/from at least one of: a base station in the mobile communication network; the external devices (e.g., the flying device 900 or the other electronic device 104); or various servers (e.g., an application server, a management server, an integration server, a provider server, a content server, an Internet server, or a cloud server). The wireless signals may include voice signals, data signals, or various types of control signals. The mobile communication module 811 may transmit a variety of data utilized for the operation of the electronic device 800 to the external devices (e.g., the flying device 900, the server 106, or the other electronic device 104) in response to a user's request.

The wireless LAN module 813, for example, may have the same, or a similar, configuration as the Wi-Fi module 223 of FIG. 2. The wireless LAN module 813 may refer to a module for wireless Internet access and for forming a wireless LAN link with other external electronic devices (e.g., the flying device 900, the other electronic device 102, or the server 106). The wireless LAN module 813 may be provided inside, or outside, the electronic device 800. The wireless Internet technology may use WiFi (wireless fidelity), Wibro (wireless broadband), WiMax (world interoperability for microwave access), HSDPA (high speed downlink packet access), or mmWave (millimeter wave). The wireless LAN module 813 may interwork with other external electronic devices (e.g., the flying device 900 or the other electronic device 104), which are connected with the electronic device 800 through a network (e.g., a wireless Internet network) (e.g., the network 162) in order to thereby transmit a variety of data of the electronic device 800 to the outside (e.g., the flying device 900), or in order to thereby receive data from the outside. The wireless LAN module 813 may remain in the on state, or may be turned on according to the configuration of the electronic device 800 or a user input.

The short-range communication module 815 may refer to a module for performing the short-range communication. The short-range communication technology may use Bluetooth, Bluetooth low energy (BLE), RFID (radio frequency identification), infrared data association (IrDA), UWB (ultra wideband), ZigBee, or NFC (near field communication). The short-range communication module 815 may interwork with other external electronic devices (e.g., the flying device 900 or the other electronic device 102), which are connected with the electronic device 800 through a network (e.g., a short-range communication network) in order to thereby transmit a variety of data of the electronic device 800 to the external electronic devices, or in order to thereby receive data from the same. The short-range communication module 815 may remain in the on state, or may be turned on according to the configuration of the electronic device 800 or a user input.

The position calculating module 817, for example, may have the same, or a similar, configuration as the GNSS module 227 of FIG. 2. The position calculating module 817 is intended to obtain the position of the electronic device 800, and may include a GPS (global positioning system) module as a typical example. The position calculating module 817 may measure the position of the electronic device 800 according to the principle of triangulation.

The user input unit 820 may create input data for controlling the operation of the electronic device 800 in response to a user input. The user input unit 820 may include one or more input devices for detecting various inputs from the user. For example, the user input unit 820 may include a keypad, a dome switch, physical buttons, a touch pad (pressure-sensitive type/capacitive type), a jog & shuttle, and sensors (e.g., the sensor module 240).

Some of the user input unit 820 may be implemented in the form of a button on the outside of the electronic device 800, or some or all of the user input unit 820 may be implemented as a touch panel. The user input unit 820 may receive a user input for initiating the operation of the electronic device 800 (e.g., a photographing function, a connectivity function of the flying device 900, a photographing function by using the flying device 900, a control function of the flying device 900, or the like), according to various embodiments of the present disclosure, and may create an input signal in response to the user input.

The touch screen 830 may refer to an input/output device that can perform both the input function and the display function, and may include a display 831 (e.g., the display 160 or 260) and a touch detecting unit 833. The touch screen 830 may: provide an input/output interface between the electronic device 800 and the user; transmit a user's touch input to the electronic device 800; and serve as a medium for displaying an output of the electronic device 800 to the user. The touch screen 830 may display a visual output to the user. The visual output may be made in the form of text, a graphic, a video, or a combination thereof.

The display 831 may display (output) a variety of information that is processed in the electronic device 800. For example, the display 831 may display a user interface (UI) or a graphic user interface (GUI) that is related to an operation of connecting to the flying device 900 by the electronic device 800, a preview image transmitted by the flying device 900, or a photographing operation by using the flying device 900. The display 831 may adopt various displays (e.g., the display 160). In various embodiments, a bent or flexible display may be used for the display 831.

The touch detecting unit 833 may be placed on the display 831, and may detect a user input made by a touch or proximity with respect to the surface of the touch screen 830. The user input may include a touch event or a proximity event, which is made based on at least one of a single-touch, a multi-touch, hovering, or an air gesture. The touch detecting unit 833, in various embodiments, may receive a user input for initiating an operation related to the usage of the electronic device 800, and may generate an input signal in response to the user input.

The audio processing unit 840, for example, may have the same, or a similar, configuration as the audio module 280 of FIG. 2. The audio processing unit 840 may perform a function of transmitting an audio signal received from the controller 880 to a speaker (SPK) 841, and a function of transmitting, to the controller 880, an audio signal, such as a voice, which is input from a microphone (MIC) 843. The audio processing unit 840 may convert voice/sound data into audible sounds in order to thereby output the same to the speaker 841 according to the control of the controller 880, and may convert audio signals, such as a voice, which are received from the microphone 843, into digital signals in order to thereby transmit the same to the controller 880.

The speaker 841 may output audio data, which is received from the wireless communication unit 810 or is stored in the memory 850. The speaker 841 may output sound signals in relation to various operations (functions), which are performed by the electronic device 800.

The microphone 843 may receive external sound signals, and may convert the same to electrical sound data. The microphone 843 may have a variety of noise reduction algorithms to remove noise generated in the course of receiving the external sound signals. The microphone 843 may play the role of inputting audio streams, such as voice instructions (for example, voice instructions to initiate a function of connecting to the flying device 900, the movement of the flying device 900, or photographing by the flying device 900).

The memory 850 (e.g., the memory 130 or 230) may store one or more programs that are executed by the controller 880, and may perform a function of temporarily storing the input/output data. The input/output data, for example, may contain files (such as moving images, images, pictures, or audio files), sensor information, position information, and pattern information for a position notification. The memory 850 may play the role of storing obtained data. The data, which is obtained in real time, may be stored in a temporary storage device, and the data, which is determined to be stored, may be stored in a permanent storage device.

In various embodiments, the memory 850 may store one or more programs, data, or instructions that are related to functions of connecting to (making a pair with) the flying device 900 through wireless communication and controlling the flying device 900 connected with the electronic device 800 based on at least some of the motion (e.g., motion data) and an identification signal (e.g., an optical signal) of the electronic device 800 in order to thereby perform the photographing. The memory 850 may include one or more application modules (or software modules).

The interface unit 860, for example, may have the same, or a similar, configuration as the interface 270 of FIG. 2. The interface unit 860 may receive data or power from other electronic devices in order to thereby transmit the same to each element inside the electronic device 800. The interface unit 860 may allow data in the electronic device 800 to be transmitted to other electronic devices. For example, the interface unit 860 may include wired/wireless headset ports, an external charger port, wired/wireless data ports, a memory card port, audio input/output ports, moving image input/output ports, an earphone port, or the like.

The camera module 870 (e.g., the camera module 291) may support a photographing function of the electronic device 800. The camera module 870 may photograph a certain subject in order to thereby transmit the photographed data (e.g., images) to the display 831 and the controller 880 under the control of the controller 880.

The sensor module 875 have the same, or a similar, configuration as the sensor module 240 of FIG. 2. In various embodiments, the sensor module 875 may detect the movement (or motion) and position of the electronic device 800, and may provide the controller 880 with sensor information according to the detection result. The sensor module 875 may include one or more sensors that can create data to be used to calculate the movement of the electronic device 800 and a change in the movement thereof. The sensors, for example, may include at least one of various sensors, such as a gyro sensor, an acceleration sensor, an angular velocity sensor, a GPS sensor, or a rotation recognition sensor. According to various embodiments, at least some of the sensor module 875 may be included in the position notification module 600, as explained in the description of FIG. 4. According to various embodiments, at least some of the sensor module 875 may detect the operation state of the electronic device 800, and may operate in the sleep mode if a specific operation (e.g., a motion) is not detected.

The position notification module 600 may include a device that provides (outputs) a configured notification in order for the flying device 900 to identify the position of the electronic device 800 or to correct the photographing position thereof. According to various embodiments, the position notification module 600 may include an flash LED that is provided on the back side of the electronic device 800. According to various embodiments, the position notification module 600 may be implemented by including at least some (e.g., an HRM sensor) of the sensor module (not shown).

The controller 880 may control the overall operations of the electronic device 800. In various embodiments, the controller 880, for example, may have the same, or similar, configuration as the processor 210 of FIG. 2. In various embodiments, the controller 880 may control an operation that is related to the automatic execution of the photographing by interworking with the flying device 900. In various embodiments, the controller 880 may process operations of connecting to (making a pair with) the flying device 900 through wireless communication and controlling the flying device 900 connected with the electronic device 800 based on at least some of the motion (e.g., motion data) and an identification signal (e.g., an optical signal) of the electronic device 800 in order to thereby perform the photographing.

The controller 880 may include one or more processors for controlling the operation of the electronic device 800. In various embodiments, the controller 880 may control the operation of hardware modules, such as the audio processing unit 840, the interface unit 860, or the display 831. The control operation of the controller 880, according to various embodiments of the present disclosure, will be described in detail with reference to the drawings illustrated below.

According to various embodiments of the present disclosure, the controller 880 may be implemented by one or more processors that control the operation of the electronic device 800, according to various embodiments of the present disclosure, by executing one or more programs, which are stored in the memory 850.

According to various embodiments of the present disclosure, the controller 880 may include a photographing processing module 885 for processing the photographing function by using the flying device 900. According to various embodiments, the photographing processing module 885, for example, may include a device control module 885A, a signal processing module 885B, and a motion processing module 885C.

According to various embodiments, the device control module 885A may control various operations of the flying device 900. For example, if the entry into the photographing mode is detected while the electronic device 800 is connected (paired) with the flying device 900, the device control module 885A may create a control signal to control the movement of the flying device 900 to the photographing position. The device control module 885A may transmit the created control signal to the flying device 900 through the wireless communication unit 810 in order to thereby control the flying device 900 to perform at least one operation of taking off, moving, or hovering. The device control module 885A may process an operation that is related to the control of the movement of the flying device 900 based on the motion data of the electronic device 800 by the motion processing module 885C.

According to various embodiments, the signal processing module 885B may make a control to generate a position notification signal by the position notification module 600 (or an identification signal for identifying the position of the electronic device 800). For example, the signal processing module 885B may control the flashing of an flash LED, which is provided on the back side of the electronic device 800, such that the flash LED outputs an optical signal according to a predetermined pattern. Alternatively, the signal processing module 885B may control the flashing of an HRM sensor, which is provided on the back side of the electronic device 800, such that the HRM sensor outputs an optical signal according to a predetermined pattern.

According to various embodiments, the motion processing module 885C may create motion data according to the motion of the electronic device 800 based on the sensor information, which is collected through the sensor module 875. The motion processing module 885C may transmit the motion data to the device control module 885A, and the device control module 885A may control the movement of the flying device 900 on the basis of the motion data.

The power supply unit 890 may receive power from the external power source or internal power source in order to thereby supply the power that is utilized for the operation of the elements under the control of the controller 880. The power supply unit 890, according to various embodiments of the present disclosure, may supply power to the display 831, the camera module 870, or the sensor module 875, or may cut off the supply of power under the control of the controller 880.

As described above, the electronic device 800, according to various embodiments of the present disclosure, may include: a communication circuit configured to form communication with a flying device that includes a camera device; a position notification device; one or more sensors configured to detect a motion of the electronic device; a processor configured to be electrically connected with the communication circuit, the position notification device, and the one or more sensors; and a memory configured to be electrically connected with the processor, such that the memory stores instructions that, when being executed, allow the processor to: transmit, to the flying device, the first signal, which instructs to perform an operation for recognizing an image signal (e.g., a position notification signal or an identification signal) of the electronic device, by using the communication circuit; provide the image signal by using the position notification device; receive, from the flying device, the second signal, which indicates that the flying device has recognized the image signal of the electronic device based on at least some of the image signal, by using the communication circuit; and transmit, to the flying device, the third signal for controlling the movement of the flying device by using the communication circuit or the position notification device.

According to various embodiments, the instructions may further allow the processor to transmit, to the flying device, the fourth signal, which instructs the flying device to photograph images by using a camera device, through the communication circuit.

According to various embodiments, the position notification device may include at least one of a flash LED, an IR LED, an HRM sensor, or an ultrasonic sensor. According to various embodiments, the position notification device may provide the image signal in a configured pattern.

According to various embodiments, the instructions may further allow the processor to: collect sensor information from the one or more sensors; determine the movement of the electronic device based on the collected sensor information; and transmit the third signal corresponding to the movement of the electronic device to the flying device.

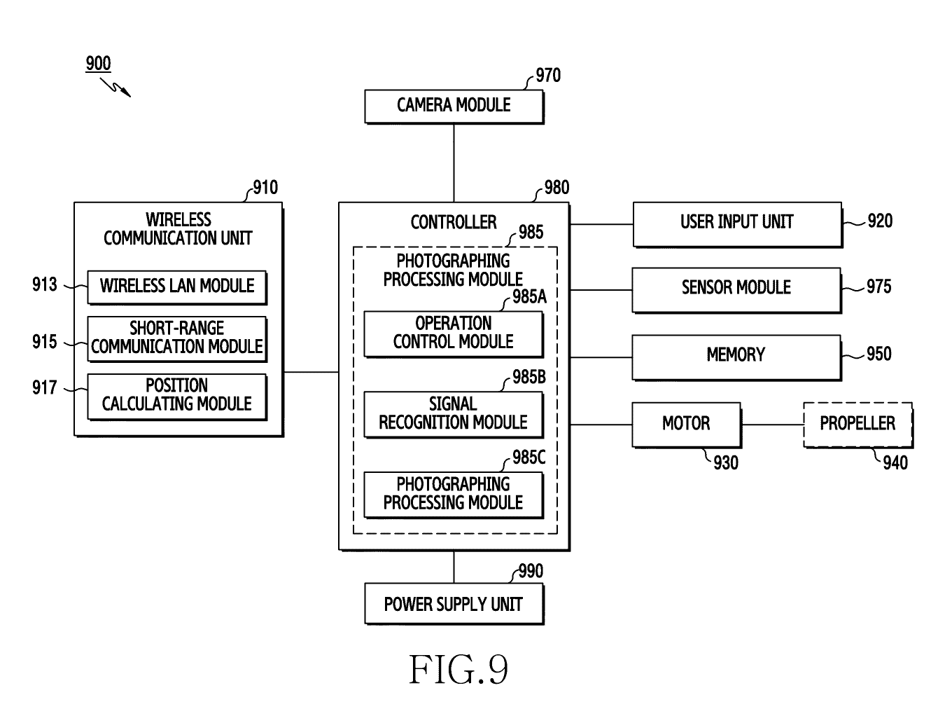

FIG. 9 is a block diagram schematically showing the configuration of a flying device, according to various embodiments of the present disclosure.

Referring to FIG. 9, the flying device 900, according to various embodiments of the present disclosure, may include a wireless communication unit 910, a user input unit 920, a memory 950, a camera module 970, a controller 980, a motor 930, a propeller 940, and a power supply unit 990, and may have the same, or a similar, configuration as the electronic device 800 of FIG. 8 described above. In various embodiments, the elements shown in FIG. 9 are not essential, so the flying device 900 may be implemented to have more elements, or fewer elements, than the elements shown in FIG. 9.

The wireless communication unit 910 may include one or more modules that enable wireless communication between the flying device 900 and other external electronic devices (e.g., the electronic device 800). For example, the wireless communication unit 910 may be configured to include a wireless LAN module 913, a short-range communication module 915, and a position calculating module 917, and may further include communication modules corresponding to the wireless communication unit 810 of FIG. 8. In various embodiments, the wireless communication unit 910 may include a module (e.g., a short-range communication module, a telecommunication module, or the like) for performing communication with the external electronic devices around the same. In various embodiments, the configuration of the wireless communication unit 910 may correspond to the configuration of the wireless communication unit 810, which has been explained in the description of FIG. 8 above, so the detailed description thereof will be omitted.

The user input unit 920 may create input data for controlling the operation of the flying device 900 in response to a user input. The user input unit 920 may receive a user input for initiating the operation of the flying device 900 {e.g., a driving operation of the flying device 900 (e.g., an operation of the propeller 940) or a photographing operation}, according to various embodiments of the present disclosure, and may create an input signal in response to the user input. The configuration of the user input unit 920 may correspond to the configuration of the user input unit 820, which has been explained in the description of FIG. 8 above, so the detailed description thereof will be omitted.

The memory 950 (e.g., the memory 130 or 230) may store one or more programs that are executed by the controller 980, and may perform a function of temporarily storing the input/output data. The input/output data, for example, may contain files (such as moving images, images, or pictures) and pattern information for recognizing the position of the electronic device 800 (e.g., the position for configuring the anchor point corresponding to the position and direction, which are determined for the photographing). The memory 950 may play the role of storing obtained data. The data, which is obtained in real time, may be stored in a temporary storage device, and the data, which is determined to be stored, may be stored in a permanent storage device.

The memory 950 may store one or more programs and data, which are related to the execution of the photographing function of the flying device 900. For example, in various embodiments of the present disclosure, the memory 950 may store one or more programs that process the operation related to the automatic execution of the photographing according to a configured photographing method at the photographing position corresponding to the anchor point and motion data of the electronic device 800, and may store data that is processed according thereto. In various embodiments, the motion data may be created by the electronic device 800 in order to control the movement of the flying device 900, and may contain a movement coordinate value. For example, the motion data may contain control signals for controlling the height (throttle), the rotation (yaw), or the horizontal translation (pitch and roll) of the flying device 900.

The memory 950 may include one or more application modules (or software modules). The application module may include instructions for performing the photographing. For example, the application module may process the operation (function) of performing the photographing in response to various controls of the electronic device 800.

In various embodiments, the memory 950 may store one or more programs, data, or instructions, which are related to functions of: connecting to (making a pair with) the electronic device 800 through wireless communication; configuring the photographing position of the flying device 900 based on at least some of the motion (e.g., motion data) and the identification signal (e.g., an optical signal) of the electronic device 800; and performing the photographing at the configured position based on signals received from the electronic device 800. The memory 950 may include one or more application modules (or software modules).

The camera module 970 (e.g., the camera module 291) may support a photographing function of the flying device 900. The camera module 970 may photograph a certain subject in order to thereby transmit the photographed data (e.g., images) to the control 980 according to the control of the controller 980. In various embodiments, the camera module 970 may be designed to be provided in a specific position (e.g., at the middle or bottom of the body of the flying device 900), in which the photographing can be performed in the flying device 900.

According to various embodiments, the camera module 970 may be implemented as a plurality of camera modules. For example, the flying device 900 may be implemented to include the first camera module and the second camera module. According to an embodiment, the flying device 900 may be implemented such that the first camera module operates for the photographing and the second camera module operates for the position recognition. According to various embodiments, the first camera module and the second camera module may operate independently according to the control of the controller 980.

The sensor module 975 have the same, or a similar, configuration as the sensor module 240 of FIG. 2. In various embodiments, the sensor module 975 may detect the movement and position of the flying device 900, and may provide the controller 980 with sensor information according to the detection result. The sensor module 975 may include one or more sensors that can create data to be used to calculate the flying (movement) of the flying device 900, the hovering thereof, or the correction of the current position to correspond to a traced (determined) position. The sensors, for example, may include at least one of various sensors, such as a gyro sensor, an acceleration sensor, an angular velocity sensor, a GPS sensor, or a rotation recognition sensor. According to various embodiments, at least some of the sensor module 975 may detect the operation state of the flying device 900, and may operate in the sleep mode if a specific operation (e.g., the movement) is not detected.

The controller 980 may control the overall operations of the flying device 900. In various embodiments, the controller 980, for example, may have the same, or a similar, configuration as the processor 210 of FIG. 2. In various embodiments, the controller 980 may control an operation related to the automatic execution of the photographing by interworking with the electronic device 800. For example, the controller 980 may receive a signal from the electronic device 800 through the wireless communication unit 910 (e.g., the short-range communication module 915), and may control the flying device 900 to move to a position for the photographing (e.g., a position corresponding to the distance and direction configured with respect to the electronic device 800) based on the obtained signal. The controller 980 may search for and recognize a position notification signal of the electronic device 800 at the moved position, and may determine an anchor point. The controller 980 may detect (receive) signals (e.g., a movement control signal or a photographing signal) transmitted from the electronic device 800 at the anchor point, and may process the operation (e.g., the moving or photographing operation of the flying device 900) corresponding to the signal.

The controller 980 may include one or more processors for controlling the operation of the flying device 900. In various embodiments, the controller 980 may control the operation of hardware modules, such as the propeller 940 (e.g., the propeller 750) or the camera module 970 of the flying device 900. According to an embodiment, the controller 980 may determine the photographing position of the flying device 900 based on at least some of the motion data of the electronic device 800 and the position notification signal of the electronic device 800, and may drive the motor 930 (e.g., the motor 298) of the flying device 900 in order to thereby control the propeller 940 (e.g., the propeller 750) of the flying device 900 such that the flying device 900 can be stationed at the determined position. In various embodiments, the controller 980 may determine the photographing timing based on timer configuration, image analysis, or the reception of a user input.

The control operation of the controller 980 and the control operation of the photographing, according to various embodiments of the present disclosure, will be described in detail with reference to the drawings illustrated below.

According to various embodiments of the present disclosure, the controller 980 may perform the photographing operation of the flying device 900 by interworking with software programs (or applications), which are stored in the memory 950. According to various embodiments of the present disclosure, the controller 980 may be implemented by one or more processors that control the operation of the flying device 900 through the execution of one or more programs, which are stored in the memory 950.

According to various embodiments of the present disclosure, the controller 980, for example, may include a photographing processing module 985. According to various embodiments, the photographing processing module 985, for example, may include an operation control module 985A, a signal recognition module 985B, and a photographing processing module 985C.

According to various embodiments, the operation control module 985A may control the operation of the propeller 940 and the camera module 970 of the flying device 900. According to various embodiments, the operation control module 985A may control the movement of the flying device 900 based on at least some of the motion data of the electronic device 800 and the image signal (e.g., a position notification signal or an identification signal) of the electronic device 800. According to various embodiments, the operation control module 985A may control the direction and position of at least one of the flying device 900 or the camera module 970 in order to detect the identification signal of the electronic device 800 in response to the reception of the operation control signal from the electronic device 800.

According to various embodiments, the signal recognition module 985B may recognize the identification signal, which is provided by the electronic device 800. According to various embodiments, the signal recognition module 985B may recognize an optical signal, which is output in a specific pattern by a flash LED, an IR LED, or an HRM sensor of the electronic device 800. According to various embodiments, the signal recognition module 985B may recognize a QR code in a specific pattern, which is attached to the electronic device 800.

According to various embodiments, the photographing processing module 985C may receive a photographing signal from the electronic device 800, and may determine the photographing execution timing in response to the photographing signal. According to various embodiments, corresponding to the photographing execution timing, the photographing processing module 985C may make a control to delay the photographing execution for a specific period of time or until a specific motion is detected.

The power supply unit 990 may receive power from the external power source or internal power source in order to thereby supply the power utilized for the operation of the elements under the control of the controller 980. According to various embodiments of the present disclosure, the power supply unit 990 may supply power to the wireless communication unit 910, the camera module 970, the sensor module 975, or the propeller 940 {e.g., motor 930 (e.g., the motor 298) for driving the propeller 750}, or may cut off the power supply under the control of the controller 980.

As described above, the flying device 900, according to various embodiments of the present disclosure, may include: a camera device; a communication circuit configured to form communication with an electronic device; one or more sensors configured to detect the movement of the flying device; a processor configured to be electrically connected with the camera device, the communication circuit, and the one or more sensors; and a memory configured to be electrically connected with the processor, such that the memory stores instructions that, when being executed, allow the processor to: receive the first signal from the electronic device by using the communication circuit; control the operation of the flying device in response to the first signal; control the camera device in order to detect an image signal (e.g., a position notification signal or an identification signal) from the electronic device; determine the position of the electronic device based on the detected image signal; receive the second signal, which instructs the movement of the flying device, from the electronic device by using the communication circuit; and control the movement of the flying device based on at least some of the second signal received and the determined position of the electronic device.

According to various embodiments, the instructions may further allow the processor to: receive the third signal from the electronic device; and perform the photographing by using the camera device in response to the third signal.

According to various embodiments, the instructions may further allow the processor to recognize the image signal from a position notification device of the electronic device. According to various embodiments, the image signal may include an optical signal that is generated by at least one of a flash LED, or an HRM sensor, of the electronic device.

According to various embodiments, the instructions may further allow the processor to: determine the photographing execution timing in response to the third signal; and to delay the photographing execution to correspond to the photographing execution timing. According to various embodiments, the instructions may further allow the processor to perform the photographing based on photographing information, which is received from the electronic device, and the photographing information may contain a photographing time or a photographing method.

Various embodiments described in the present disclosure may be implemented in a computer or a similar device-readable recording medium through software, hardware or a combination thereof.

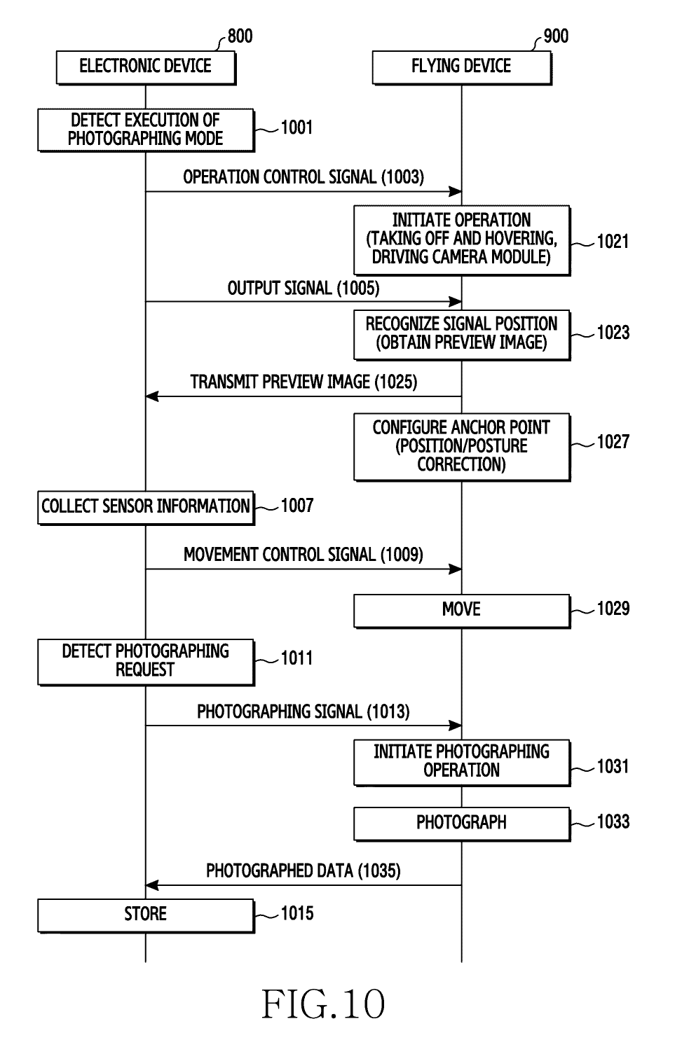

FIG. 10 is a view to explain the operation between the electronic device and the flying device in the system, according to the embodiment of the present disclosure.

Referring to FIG. 10, in operation 1001, the electronic device 800 may detect the execution of the photographing mode. For example, the user may manipulate the electronic device 800 in order to execute a photographing function or application using the flying device 900. The electronic device 800 may determine whether or not to execute (or enter) the photographing mode in response to the user's input or manipulation. According to various embodiments, the electronic device 800 and the flying device 900 may be in the state in which they are operatively and/or communicatively connected (e.g., paired) with one another based on, for example, wireless communication. For example, the electronic device 800 and the flying device 900 may be communicatively connected with one another prior to the execution of the photographing mode. As another example, when the electronic device 800 executes the photographing mode in tandem with the flying device 900, the electronic device 800 and the flying device 900 may perform connection establishment (e.g., pairing) operation.

In operation 1003, the electronic device 800 may transmit an operation control signal to the flying device 900 in response to detecting the execution of a photographing mode. According to various embodiments, the operation control signal may contain a signal to initiate the operation of the flying device 900.

In operation 1021, the flying device 900 may initiate particular operations in response to the reception of the operation control signal from the electronic device 800. For example, if the flying device 900 detects the reception of the operation control signal, the flying device 900 may process the operations to execute take-off and hovering. In various embodiments, the flying device 900 may be configured to maintain a waiting or standby state for detecting signals from the electronic device 800 when the flying device 900 is communicatively connected (e.g., paired) with the electronic device 800. According to various embodiments, when the operation control signal is received in the standby state, the flying device 900 may drive (e.g., activate or “turn on”) the camera module 970. In various embodiments, the camera module 970 may be activated when connecting to the electronic device 800, or may be activated according to the user's intentional control which is input using the electronic device 800.

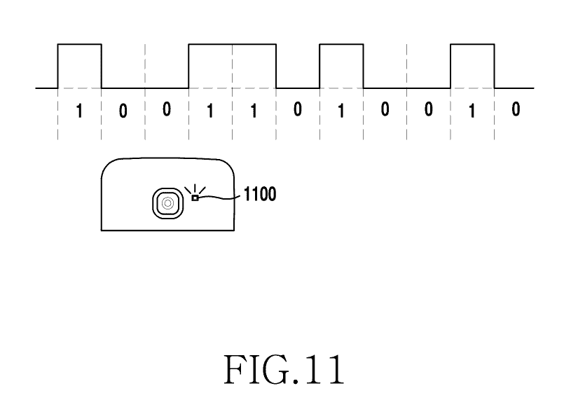

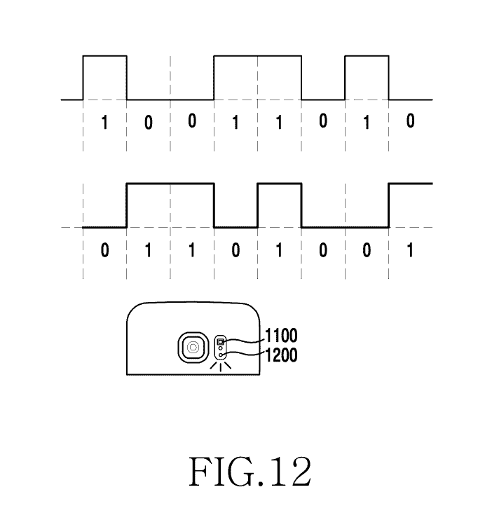

In operation 1005, the electronic device 800 may output a signal. According to various embodiments, the electronic device 800 may control the position notification module 600 to output a position notification signal. In various embodiments, the position notification module 600 may be disposed on a portion of the housing 500 of the electronic device 800 (e.g., the back side of the electronic device 800). The position notification module 600 may include a device that provides (e.g., outputs) a configured notification to enable the flying device 900 to identify the position of the electronic device 800 by detection of the configured notification, which may then be used by the flying device 900 to correct the spatial photographing position of the flying device 900. According to various embodiments, the position notification module 600 may include a flashing LED that is disposed on the back side of the electronic device 800. According to various embodiments, the position notification module 600 may be implemented by including at least some (e.g., an HRM sensor) of the sensor module 875. The position notification signal may be contained in the image signal that is generated by the position notification module 600, and, for example, may contain an optical signal generated according to the flashing of the LED, or an optical signal generated according to the flashing of the HRM sensor. According to various embodiments, the position notification signal may be generated in a specific pattern in order to improve or facilitate recognition by the flying device 900, and the accuracy thereof. The operation of generating the position notification signal by the position notification module 600, according to various embodiments, will be described with reference to FIGS. 11 to 13 illustrated below.

In operation 1023, the flying device 900 may process an operation for recognizing the positioning of the signal. According to various embodiments, the flying device 900 may perform a search operation attempting to detect the position of the electronic device 800 (or a photographing position or a target point) after or while hovering. According to various embodiments, the flying device 900 may search for a signal by the position notification module 600 of the electronic device 800 by rotating (for example, rotating clockwise or counterclockwise) about a fixed rotational axis of the flying device 900 (e.g., the center point of the flying device 900) after hovering, until the position notification signal is in a particular field of view. According to an embodiment, the flying device 900 may search for a signal (e.g., an LED flashing signal, an HRM sensor flashing signal, or a QR code), which is output from the position notification module 600 of the electronic device 800, in order to thereby recognize the position of the electronic device 800 (or the user).

According to various embodiments, the flying device 900 may obtain an image (e.g., a preview image) through the camera module 970, while (or before) searching for the position notification signal, and may transmit the obtained preview image to the electronic device 800 in operation 1025. Although it is not shown in the drawings, the electronic device 800 may receive the preview image transmitted from the flying device 900 after entering the photographing mode, and may display, as a preview, the received image on the display 831.

In operation 1027, the flying device 900 may configure an anchor point. According to various embodiments, the flying device 900 may configure the anchor point for executing photography based on the position and direction in which the output position notification signal of the position notification module 600 of the electronic device 800 is recognized. In various embodiments, the anchor point may correspond to the position and direction of electronic device 800 in which the position notification signal of the electronic device 800 is recognized by the flying device 900 while disposed in a particular orientation while hovering, and the flying device 900 may perform the position/posture correction (for example, rotation or revolution) for the configuration of the anchor point while hovering. According to an embodiment, the flying device 900 may perform the preview image transmission operation to the electronic device 800 (e.g., operation 1025) after the configuration of the anchor point.

In operation 1007, the electronic device 800 may collect sensor information. According to various embodiments, the electronic device 800 may collect sensor information related to the movement of the electronic device 800 based on the sensor module 875. In various embodiments, the electronic device 800 may obtain motion data based on the collected sensor information. In various embodiments, the motion data is information for controlling the movement of the flying device 900 (e.g., the movement/posture correction for configuring a final photographing position), and may be a movement coordinate value. In various embodiments, the motion data may contain control signals for controlling the height (e.g., throttle), the rotation (e.g., yaw), or the horizontal translation (e.g., pitch and roll) of the flying device 900.

In operation 1009, a movement control signal (e.g., the motion data) may be transmitted to the flying device 900 based on the collected sensor information.

In operation 1029, the flying device 900 may move in response to the reception of the movement control signal from the electronic device 800. For example, when the motion data is received from the electronic device 800, the flying device 900 may move as to alter its positioning in accordance and/or corresponding to the received motion data. As another example, the flying device 900 may continue to trace the output signal of the position notification module 600 of the electronic device 800 during the movement, and may correct the photographing position based on the output signal of the position notification module 600. As another example, the flying device 900 may move (e.g., fly) to a photographing position desired by the user by using the anchor point, in which the output signal of the position notification module 600 of the electronic device 800 is recognized, and the motion data received from the electronic device 800. According to an embodiment, the flying device 900 may continue to execute and/or repeat the operations of receiving the movement control signal (e.g., operation 1009) and the moving (e.g., operation 1029) until a photographing request signal is received from the electronic device 800.

In operation 1011, the electronic device 800 may detect a photographing request by the user. For example, the user may manipulate the electronic device 800 in order to perform the photographing using the flying device 900. According to an embodiment, the user may transmit a photographing instruction to the electronic device 800 based on, for example, the selection of a software photographing button that is provide through the display 831 of the electronic device 800, the selection of a hardware photographing button that is formed in or exposed through the housing 500 of the electronic device 800 to provide a photographing function, or the input of a voice instruction received via the microphone 843 of the electronic device 800.

In operation 1013, the electronic device 800 may transmit a photographing signal to the flying device 900 in response to the detection of the photographing request from the user.

In operation 1031, the flying device 900 may initiate a photographing operation. In various embodiments, when the photographing signal is received from the electronic device 800, the flying device 900 may fix the hovering position of the flying device 900, and may determine the photographing timing based on configured photographing information. For example, the photographing information may be pre-configured to then be stored in at least one of the electronic device 800 or the flying device 900, and, for example, may contain operation information to determine whether or not to start the photographing (e.g., photographing timing information) at a fixed position. Alternatively, the photographing information may contain information about a photographing method (e.g., panoramic photographing, multi-shot photographing, effect photographing, or the like) performed during the photographing. According to various embodiments, the operation information is intended to recognize the photographing timing, and, for example, may contain: information on the photographing standby time (e.g., 3 seconds or 5 seconds) after the reception of the photographing signal, instruction information for tracing the electronic device 800 after the reception of the photographing signal, instruction information for waiting for the reception of a voice instruction after the reception of the photographing signal, and instruction information for recognizing the user's face after the reception of the photographing signal. According to an embodiment, the flying device 900 may automatically perform the photographing after waiting for a predetermined period of time (e.g., 3 seconds or 5 seconds) after the reception of the photographing signal. According to an embodiment, the flying device 900 may trace the electronic device 800 after the reception of the photographing signal, and may automatically perform the photographing in response to the detection that the electronic device 800 or the position notification module 600 of the electronic device 800 disappears from the view point. According to an embodiment, the flying device 900 may automatically perform the photographing in response to the detection of a user's voice instruction (e.g., a voice command such as “shoot!”), or in response to the reception of a voice instruction from the electronic device 800 after the reception of the photographing signal.

According to various embodiments, the electronic device 800 may stop collecting the sensor information of the electronic device 800 at the time of transmitting the photographing signal, and may not generate a signal related to the movement control of the flying device 900.

In addition, the flying device 900 may fix the position and direction thereof at the time of receiving the photographing signal.

In operation 1033, the flying device 900 may perform the photographing at the time of determining the photographing.

In operation 1035, the flying device 900 may transmit, to the electronic device 800, photographed data that is obtained through the photographing.

In operation 1015, the electronic device 800 may receive the photographing data from the flying device 900, and may store the received photographing data in the memory (e.g., element 950 of FIG. 9). According to various embodiments, when the photographed data is received, the electronic device 800 may display the received photographed data through the display 831, in addition to the storing of the received photographing data, according to the option configuration of the electronic device 800.

According to various embodiments, the flying device 900 may store the photographed data, which is obtained through the photographing. According to an embodiment, the flying device 900 may: store the photographed data in the internal memory of the flying device 900 instead of transmitting the photographed data (e.g., operation 1035); then determine a configured policy (e.g., a request of the electronic device 800 or the timing of completing the photographing operation); and transmit the stored photographed data to the electronic device 800 based on the determination result. For example, the flying device 900 may transmit the photographed data to the electronic device 800 in real time, or may store the photographed data to be accumulated and then may collectively transmit the photographed data to the electronic device 800.

According to various embodiments, the flying device 900 may transmit the photographed data, which is different from the data that is actually photographed, when transmitting the photographed data. According to an embodiment, the preview image displayed in the electronic device 800 may be different from the actually photographed data in the size. For example, in order to overcome the limitations of the data transmission between the electronic device 800 and the flying device 900, the actually photographed data (e.g., high quality photographed data) may be stored in the flying device 900 for a later transmission instead of being directly transmitted to the electronic device 800, and low quality photographed data (e.g., for the preview image) may be transmitted to the electronic device 800.

FIGS. 11 to 13 are views illustrating an example for generating the position notification signal in the electronic device, according to the embodiment of the present disclosure.

Referring to FIG. 11, the electronic device 800, according to an embodiment, may implement the position notification module 600 by using a flash LED 1100 that is provided on the back side of the electronic device 800. When the electronic device 800 performs the photographing operation by interworking with the flying device 900, the electronic device 800 may control the flashing of the flash LED 1100 to allow the flying device 900 to recognize the same. In various embodiments, the electronic device 800 may control the flash LED 1100 to flash on and off to correspond to a specific pattern, as represented here via changing of one bit (e.g., 10011010010, so that “1” may indicate “light on” and “0” may indicate “light off”). The flying device 900 may recognize the LED flashing pattern of the flash LED 1100 of the electronic device 800 to perform the operation of configuring the anchor point. In various embodiments, the flying device 900 may more accurately recognize the position of the electronic device 800 (such as, for example, improving the recognition rate of the flying device 900) through the position notification signal in a specific pattern, and the flashing pattern may be predefined between the electronic device 800 and the flying device 900.

Referring to FIG. 12, the electronic device 800, according to an embodiment, may implement the position notification module 600 by using a flash LED 1100 combined with an HRM sensor 1200, which are provided on the back side of the electronic device 800. For example, the electronic device 800 may include the HRM sensor 1200 for measuring a user's biometric information (e.g., the heart rate), and the HRM sensor 1200 may include a red LED. When the electronic device 800 performs the photographing operation by interworking with the flying device 900, the electronic device 800 may control the flashing of the flash LED 1100 and the HRM sensor 1200 to allow the flying device 900 to recognize the same. In various embodiments, the electronic device 800 may control the flash LED 1100 and the HRM sensor 1200 to simultaneously flash on and off to correspond to a specific pattern of two bits (e.g., 10011010 for the flash LED and 01101001 for the HRM sensor). The flying device 900 may recognize the LED flashing pattern of the flash LED 1100 and the HRM sensor 1200 of the electronic device 800 in order to thereby perform the operation of configuring the anchor point. In various embodiments, the flying device 900 may more accurately and clearly identify the position notification signal of the electronic device 800 (for example, improving the recognition rate of the flying device 900) through the flashing pattern of two bits by using the flash LED 1100 and the HRM sensor 1200, and the flashing pattern may be predefined between the electronic device 800 and the flying device 900.

According to various embodiments, the output information (e.g., a specific pattern) of the position notification module 600 may be used as information in order for the flying device 900 to identify the electronic device 800, as well as to identify the position of the electronic device 800. For example, if there are other electronic devices near the flying device 900 or the electronic device 800, the flying device 900 may recognize a determined pattern in order to thereby identify the electronic device 800 among various nearby electronic devices.

Referring to FIG. 13, FIG. 13 illustrates another example in which the flying device 900 recognizes the position of the electronic device 800 (e.g., recognizes the absolute coordinates of the electronic device 800) based on images, patterns or codes disposed on a surface of the electronic device 800, such as a back surface. According to various embodiments, the electronic device 800 may be implemented to include an IR LED (not shown) or an QR code 1300 for the position recognition on the back side thereof. For example, according to various embodiments, the flashing of the IR LED or the QR code 1300 may be recognized to then be used as the primary absolute coordinates of the motion of the electronic device 800.

As described above, in various embodiments, the information to recognize the position of the electronic device 800 may be provided by using at least some of the flash LED 1100, the HRM sensor 1200, the IR LED (not shown), or the QR code 1300. The flying device 900 may recognize the information for the position recognition of the electronic device 800, and may trace the information in order to thereby move to correspond to the motion of the electronic device 800. Therefore, in various embodiments, the flying device 900 may more accurately trace the position by using the motion data, which is received from the electronic device 800, and the position notification signal, which is provided by the electronic device 800.

In various embodiments, the description will be made of an example in which the flying device 900 recognizes the position of the electronic device 800 based on a visual factor by the position notification module 600. However, the present disclosure is not limited thereto, and, according to various embodiments, additionally or alternatively, the flying device 900 may perform the position recognition by using an auditory factor. For example, additionally or alternatively to the position notification module 600, the electronic device 800 may output an auditory factor (e.g., ultrasonic waves) for the auditory recognition, and the flying device 900 may trace and recognize the auditory factor of the electronic device 800 in order to thereby recognize the position of the electronic device 800.

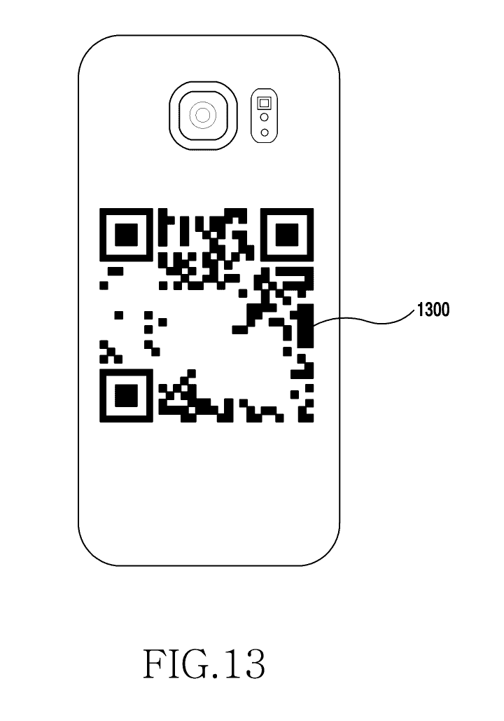

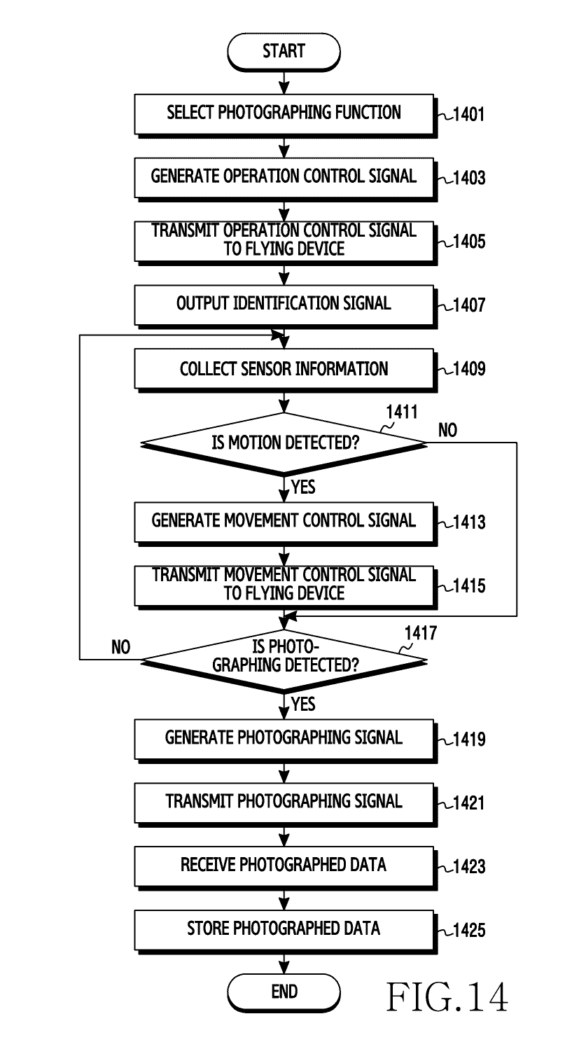

FIG. 14 is a flowchart to explain the operation of the electronic device, according to various embodiments of the present disclosure.

Referring to FIG. 14, if the controller 880 of the electronic device 800 detects the selection of a photographing function by the user in operation 1401, the controller 880 of the electronic device 800 may generate an operation control signal in operation 1403. According to various embodiments, the electronic device 800 and the flying device 900 may be in the state in which they are communicatively connected (e.g., paired) with each other based on wireless communication, and if they are not in the connected state, a connection operation may be performed. When the controller 880 detects the selection of the photographing function (e.g., selfie photographing) while the electronic device 800 and the flying device 900 are connected with each other, the controller 880 may generate the operation control signal for controlling the operation of the flying device 900.

In operation 1405, the controller 880 may transmit the operation control signal to the flying device 900. In various embodiments, the operation control signal may include a signal to initiate the operation of the flying device 900 (such as, for example, taking off and hovering, driving the camera, or the like).

In operation 1407, the controller 880 may process the output of an identification signal. According to various embodiments, the controller 880 may process the output of a position notification signal in a specific pattern, as explained in the description of FIGS. 11 to 13 illustrated above. According to various embodiments, the controller 880 may control the position notification module 600 to output the position notification signal. In various embodiments, the method of using the QR code, as shown in FIG. 13, may exclude operation 1407.

The controller 880 may collect sensor information based on at least some of the sensor module 875 in operation 1409, and may determine the motion of the electronic device 800 based on the collected sensor information in operation 1411.

If it is determined (e.g., detected) that the electronic device 800 does not make a motion based on the sensor information in operation 1411, the controller 880 may proceed to operation 1417 in order to thereby process the execution of operation 1417 and subsequent operations thereof.

If it is determined (e.g., detected) that the electronic device 800 makes a motion based on the sensor information in operation 1411, the controller 880 may generate a movement control signal for the movement control of the flying device 900 based on the sensor information in operation 1413. The controller 880 may collect the sensor information, which is related to the movement of the electronic device 800, based on the sensor module 875. In various embodiments, the electronic device 800 may obtain motion data based on the collected sensor information. In various embodiments, the motion data is information to control the movement of the flying device 900 (e.g., the movement/posture correction to configure a final photographing position), and may be a movement coordinate value. In various embodiments, the motion data may contain control signals for controlling the height (e.g., throttle), rotation (e.g., yaw), or horizontal translation (e.g., pitch and roll) of the flying device 900.

In operation 1415, the controller 880 may transmit the movement control signal to the flying device 900 in response to the detection of the motion of the electronic device 800. In various embodiments, the movement control signal may contain a signal to control the movement of the flying device 900 (e.g., including the height via throttle, rotation via yaw, or horizontal translation via pitch and roll. In various embodiments, the movement control signal may contain movement coordinate data through the wireless communication or an output through the position notification module 600.

In various embodiments, the movement of the flying device 900, according to the movement control signal, may be performed based on the movement control signal of the electronic device 800. Alternatively, the flying device 900 may directly calculate a movement position value corresponding to the movement control signal, and may operate to move based on the calculated position value. That is, the movement position of the flying device 900 may be determined by at least one of the electronic device 800 or the flying device 900. For example, the electronic device 800 may calculate a sensor value, which is obtained through the sensor of the electronic device 800 as operation 1415, and may then transmit the same as the movement control signal to the flying device 900. As another example, the electronic device 800 may directly transmit the obtained sensor value to the flying device 900, and the flying device 900 may calculate a position value based on the sensor value in order to thereby operate to move according thereto.

In operation 1417, the controller 880 may determine whether or not a photographing request from the user is detected. For example, the user may manipulate the electronic device 800 to perform the photographing by using the flying device 900. According to an embodiment, the user may transmit a photographing instruction to the electronic device 800 based on: the selection of a software photographing button provided through the display 831 of the electronic device 800, the selection of a hardware photographing button that is formed in the housing 500 of the electronic device 800 to provide a photographing function, or the input of a configured voice instruction by using the microphone 843 of the electronic device 800.

If the photographing request is not detected in operation 1417, the controller 880 may proceed to operation 1409 in order to thereby control the execution of operation 1409 and subsequent operations thereof.

If the photographing request is detected in operation 1417, the controller 880 may generate a photographing signal in operation 1419, and may transmit the photographing signal to the flying device 900 in operation 1421. According to various embodiments, the electronic device 800 may stop collecting the sensor information of the electronic device 800 at the time of transmitting the photographing signal, and may not generate a signal related to the movement control of the flying device 900.

In operation 1423, the controller 880 may receive photographed data after transmitting the photographing signal, and in operation 1425, the controller 880 may store the received photographed data in the memory 850. According to various embodiments, in the case where the flying device 900 stores the photographed data and transmits the photographed data later, operation 1423 and operation 1425 may be omitted. For example, after transmitting the photographing signal, the electronic device 800 may receive the photographed data from the flying device 900 later based on a configured policy (e.g., by a request of the electronic device 800, the timing of when the flying device 900 completes the photographing operation, or the like), and may store the same, instead of storing the photographed data in real time.

As described above, according to various embodiments, the controller 880 of the electronic device 800 may transmit the first signal to the flying device 900 by using a communication circuit (e.g., the wireless communication unit 810). In various embodiments, the first signal may contain a signal (e.g., an operation control signal) that instructs the flying device 900 to prepare (wait) for the operation of recognizing (obtaining) a visual signal (e.g., the position notification signal or the identification signal). The controller 880 may make a control to provide (generate) an image signal (e.g., an optical signal) by using a light emitting device (e.g., the position notification module 600) in parallel, or in sequence, with respect to the transmission of the first signal to the flying device 900. The controller 880 may receive the second signal from the flying device 900 by using the communication circuit. In various embodiments, the second signal may contain a signal indicating that the flying device 900 has determined the position of the electronic device 800 based on the recognition of the image signal of the light emitting device. The controller 880 may transmit the third signal to the flying device 900 by using the communication circuit. In various embodiments, the third signal may contain a signal for controlling the movement of the flying device 900 (e.g., the movement control signal or the motion data of the electronic device 800). The controller 880 may transmit the fourth signal to the flying device 900 by using the communication circuit. In various embodiments, the fourth signal may contain a signal (e.g., the photographing signal) that instructs the flying device 900 to photograph images by using the camera module 970. According to various embodiments, the electronic device 800 may store, in the memory 850, instructions that are related to the execution of the operation of the controller 880 described above.

As described above, the operating method of the electronic device 800, according to various embodiments of the present disclosure, may include: transmitting, to a flying device, the first signal, which instructs to perform an operation for recognizing an image signal (e.g., the position notification signal or the identification signal) of the electronic device; providing the image signal; receiving, from the flying device, the second signal, which indicates that the flying device has recognized the image signal of the electronic device based on at least some of the image signal; and transmitting, to the flying device, the third signal for controlling the movement of the flying device.

According to various embodiments, the method may further include transmitting, to the flying device, the fourth signal, which instructs the flying device to photograph images by using a camera device.

According to various embodiments, the image signal may include a signal that is output based on at least one of a flash LED, an IR LED, an HRM sensor, or an ultrasonic sensor, of the electronic device, and may be provided in a configured pattern.

According to various embodiments, the transmitting of the third signal may include: collecting sensor information from one or more sensors; determining the movement of the electronic device based on the collected sensor information; and transmitting, to the flying device, the third signal corresponding to the movement of the electronic device.

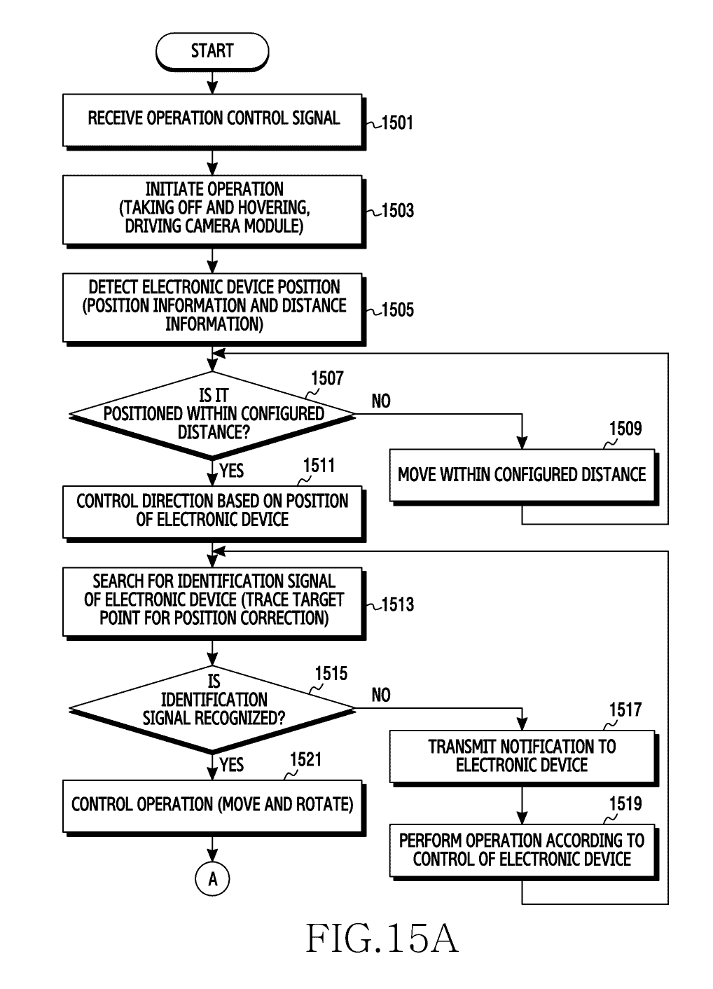

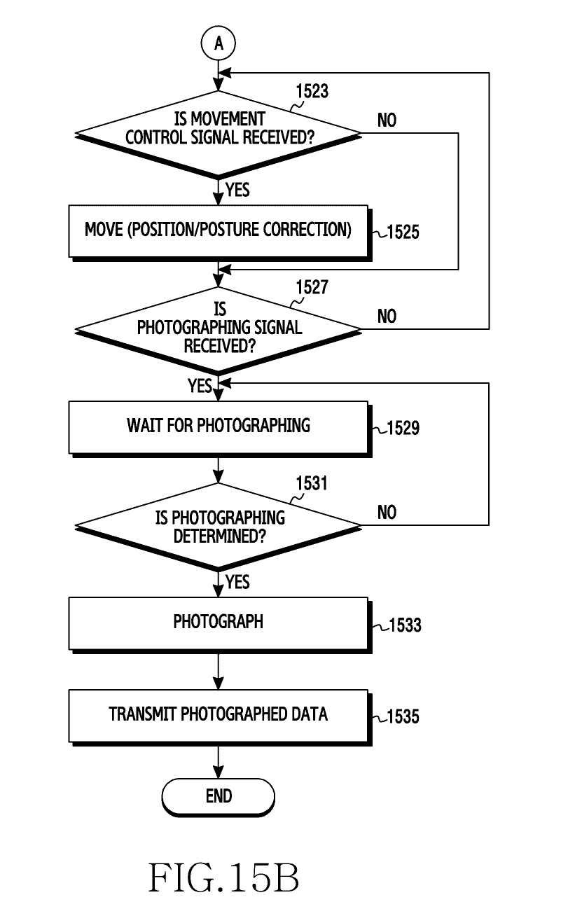

FIGS. 15A and 15B are flowcharts illustrating an operating method of the flying device, according to various embodiments of the present disclosure.

Referring to FIGS. 15A and 15B, in operation 1501, the controller 980 of the flying device 900 may receive an operation control signal from the electronic device 800. According to various embodiments, the flying device 900 and the electronic device 800 may be in the state in which they are communicatively connected (e.g., paired) with each other based on wireless communication, or a connection operation may be performed by a connection request. The flying device 900 may detect the reception of the operation control signal in the standby state in which signals can be received from the electronic device 800.

In operation 1503, the controller 980 may initiate the operation in response to the operation control signal. For example, the controller 980 may process the operation related to the take-off (such as, for example, vertical take-off or moving from the current position to the level of a specific height) and hovering of the flying device 900. In various embodiments, the controller 980 may drive (e.g., activate or “turn on”) the camera module 970 in parallel, or in sequence, with respect to the timing of connecting to (e.g., being paired with) the electronic device 800 or the timing of receiving the operation control signal. In various embodiments, the camera module 970 may be activated according to the intentional control of the user by the electronic device 800.

In operation 1505, after the taking off (e.g., vertically moving from the current position to fly at a particular height) and hovering of the flying device 900, the controller 980 may detect the position of the electronic device 800 or the distance to the electronic device 800, and may determine whether or not the flying device 900 is positioned within a configured distance of the electronic device 800 in operation 1507. For example, based on the first position information of the electronic device 800 (e.g., the coordinates of the electronic device 800) and the second position information of the flying device 900 (e.g., the coordinates of the flying device 900), the controller 980 may determine the distance between the flying device 900 and the electronic device 800 (e.g., the distance based on the difference between the first position information and the second position information) (e.g., a relative position). The controller 980 may determine whether or not the distance between the flying device 900 and the electronic device 800 is within a predetermined specific distance (e.g., 3 m, 5 m, or 10 m) based on the determination result. In various embodiments, the first position information of the electronic device 800 may be transmitted from the electronic device 800 to the flying device 900 when the electronic device 800 and the flying device 900 are communicatively connected with each other, or when the electronic device 800 transmits the operation control signal to the flying device 900. According to various embodiments, the electronic device 800 may include the position information for taking off and hovering of the flying device 900 in the operation control signal to be provided, and the flying device 900 may take off and move to the position and orientation corresponding to the position information (e.g., the coordinates) when initiating the operation according to the operation control signal, and may hover in that position and orientation. In this case, operation 1507 and operation 1509 may be omitted.

If it is determined that the distance between the flying device 900 and the electronic device 800 is not within the configured distance in operation 1507, the controller 980 may control the movement of the flying device 900 such that the flying device 900 is positioned within the configured distance based on the position of electronic device 800 in operation 1509. The controller 980 may proceed to operation 1507 in parallel, or in sequence, with respect to the movement control of the flying device 900 in order to thereby process the execution of operation 1507 and subsequent operations thereof.

If it is determined the distance between the flying device 900 and the electronic device 800 is within the configured distance in operation 1507, the controller 980 may control the position and direction of the flying device 900 based on the position of the electronic device 800 in operation 1511. According to various embodiments, the controller 980 may to direct the flying device 900 or the camera module 970 towards the position of the electronic device 800.

In operation 1513, the controller 980 may search for an identification signal of the electronic device 800. For example, the controller 980 may attempt detection or recognition of a light signal flashing in a specific pattern, as provided by the position notification module 600 of the electronic device 800. According to various embodiments, the controller 980 may control the flying device 900 to perform a search operation to recognize the position (or a photographing position or a target point) of the electronic device 800 after the taking off and hovering. According to various embodiments, the controller 980 may search for a signal by the position notification module 600 of the electronic device 800 while rotating about a fixed rotational axis of the flying device 900 (e.g., the center point of the flying device 900) after hovering. According to an embodiment, the controller 980 may search for a signal (e.g., an LED flashing signal, an HRM sensor flashing signal, or a QR code), which is output from the position notification module 600 of the electronic device 800, in order to thereby recognize the position of the electronic device 800 (or the user).

In operation 1515, the controller 980 may determine whether or not the identification signal is recognized. According to various embodiments, the controller 980 may perform the search of the identification signal of the electronic device 800 for a predetermined period of time (e.g., 5 seconds, 10 seconds, 30 seconds, or the like).

If no identification signal is recognized in operation 1515, the controller 980 may transmit to the electronic device 800 a notification in accordance with non-recognition of the identification signal in operation 1517. For example, the controller 980 may transmit, to the electronic device 800, information stating that no identification signal of the electronic device 800 has been recognized. According to various embodiments, when the notification according to the non-recognition of the identification signal is received from the flying device 900, the electronic device 800 may display information (e.g., error information) corresponding to the notification through the display 831. According to various embodiments, in response to the reception of the notification, the electronic device 800 may switch to a control mode in which the movement of the flying device 900 can be controlled (e.g., a mode in which the control signal can be generated by the detection of the motion of the electronic device 800 as described above), or may display a related user interface that enables the control of the movement of flying device 900. The electronic device 800 may transmit, to the flying device 900, a movement control signal corresponding to the manipulation of the user.

In operation 1519, the controller 980 may process the execution of the operation corresponding to the control of the electronic device 800. For example, the controller 980 may control the movement of the flying device 900 in response to the movement control signal of the electronic device 800. The controller 980 may proceed to operation 1513 in parallel, or in sequence, with respect to the movement control of the electronic device 800 in order to thereby process the execution of operation 1513 and subsequent operations thereof.

If the identification signal is recognized in operation 1515, the controller 980 may control the operation of the flying device 900 based on the identification signal of the electronic device 800 in operation 1521. For example, the controller 980 may configure an anchor point through the movement or rotation of the flying device 900 and through the position/posture correction of the flying device 900 for the photographing based on the identification signal of the electronic device 800. According to various embodiments, the controller 980 may configure, as the anchor point for the photographing, the position and direction in which the output signal of position notification module 600 of the electronic device 800 is detected. In various embodiments, the anchor point may include the position and direction in which the position notification signal of the electronic device 800 is received at the position where the flying device 900 hovers, and the flying device 900 may perform the position/posture correction (for example, rotation or revolution) for configuring the anchor point after the hovering.

In operation 1523, the controller 980 may determine whether or not the movement control signal is received from the electronic device 800.

If the movement control signal is not received from the electronic device 800 in operation 1523, the controller 980 may proceed to operation 1527 in order to thereby process the execution of operation 1527 and subsequent operations thereof.

If the movement control signal is received from the electronic device 800 in operation 1523, the controller 980 may control the movement of the flying device 900 in response to the movement control signal in operation 1525. For example, the user may check a preview image transmitted from the flying device 900 through the display 831 of the electronic device 800, and thus may perform the manipulation (operation) for the movement of the flying device 900 in order to change the photographing composition. The electronic device 800 may transmit, to the flying device 900, the movement control signal for controlling the movement of the flying device 900 in response to the user's manipulation. When the movement control signal is received from the electronic device 800, the controller 980 of the flying device 900 may control the movement of the flying device 900 in response to the movement control signal. According to various embodiments, the controller 980 may make a control to trace the identification signal of the electronic device 800 during the movement of the flying device 900 in order to thereby correct the photographing position/posture based on the identification signal of the electronic device 800.

In operation 1527, the controller 980 may determine whether or not a photographing signal is received from the electronic device 800.

If the photographing signal is not received from the electronic device 800 in operation 1527, the controller 980 may proceed to operation 1523 in order to thereby process the execution of operation 1523 and subsequent operations thereof.

If the photographing signal is received from the electronic device 800 in operation 1527, the controller 980 may wait to photograph in operation 1529, and may determine whether or not to photograph images in operation 1531. For example, if the photographing signal is received from the electronic device 800, the controller 980 may operate to fix the position of the flying device 900, and may determine the photographing timing based on the configured photographing information. In various embodiments, the photographing information may be preconfigured to then be stored in at least one of the electronic device 800 or the flying device 900, and, for example, may contain operation information to determine whether or not to start to photograph images (e.g., photographing timing information) at a fixed position. Alternatively, the photographing information may contain information about a photographing method (e.g., panoramic photographing, multi-shot photographing, effect photographing, or the like) performed during the photographing. According to various embodiments, the operation information is intended to recognize the photographing timing, and, for example, may contain:

information on the photographing standby time (e.g., 3 seconds or 5 seconds) after the reception of the photographing signal; instruction information for tracing the electronic device 800 after the reception of the photographing signal; instruction information for waiting for the reception of a voice instruction after the reception of the photographing signal; and instruction information for recognizing the user's face after the reception of the photographing signal. According to an embodiment, the controller 980 may wait for a predetermined time (e.g., 3 seconds or 5 seconds) after the reception of the photographing signal, and may determine the execution of the photographing when the predetermined time has elapsed. According to an embodiment, the controller 980 may trace the electronic device 800 after the reception of the photographing signal, and may determine the execution of the photographing in response to the detection that the electronic device 800 or the position notification module 600 of the electronic device 800 disappears from the view point. According to an embodiment, the controller 980 may determine the execution of the photographing in response to the detection of a user's voice instruction (e.g., “shoot!”), or in response to the reception of a voice instruction from the electronic device 800 after the reception of the photographing signal.

If the execution of the photographing is not determined in operation 1531, the controller 980 may proceed to operation 1529 in order to thereby process the execution of operation 1529 and subsequent operations thereof.

If the execution of the photographing is determined in operation 1531, the controller 980 may control the photographing based on the camera module 970 in operation 1533.

In operation 1535, the controller 980 may make a control to transmit photographed data to the electronic device 800. According to an embodiment, in the case where the flying device 900 stores the photographed data and transmits the same later, operation 1535 may be omitted, and the operation of storing the photographed data may be carried out. According to an embodiment, the controller 980 may perform the storage and transmission of the photographed data in parallel. According to an embodiment, the controller 980 may make a control to lower the quality (e.g., low definition) of the photographed data to be transmitted to the electronic device 800 in order to thereby increase the transmission rate, and may make a control to store the actually photographed data in the flying device 900 to then be transmitted later.

As described above, according to various embodiments, the controller 980 of the flying device 900 may receive the first signal (e.g., the operation control signal) from the electronic device 800 by using the communication circuit (e.g., the wireless communication unit 910), and may control the operation of the flying device 900 in response to the first signal. The controller 980 may control the camera module 970 in order to detect the image signal (e.g., the position notification signal or the identification signal) from the electronic device 800. The controller 980 may determine the position of the electronic device 800 based on the detected image signal. The controller 980 may receive the second signal from the electronic device 800 by using the communication circuit. In various embodiments, the second signal may contain a signal to instruct the movement of the flying device 900 (e.g., the movement control signal). The controller 980 may control the movement of the flying device 900 (the position/posture correction to configure the photographing composition) based on at least some of the second signal received and the determined position of the electronic device 800. According to various embodiments, the controller 980 may receive the third signal (e.g., the photographing signal) from the electronic device 800, and may control the photographing (e.g., image capturing) by using the camera module 970 in response to the third signal. According to various embodiments, the controller 980 may operate to recognize a light from the light emitting device (e.g., the position notification module 600) of the electronic device 800. According to various embodiments, the flying device 900 may store, in the memory 950, instructions that are related to the execution of the operation of the controller 980 described above.

As described above, the operating method of the flying device 900, according to various embodiments of the present disclosure, may include: receiving the first signal from an electronic device; controlling the operation of the flying device in response to the first signal; controlling a camera device in order to detect an image signal (e.g., the position notification signal or the identification signal) from the electronic device; determining the position of the electronic device based on the detected image signal; receiving the second signal, which instructs the movement of the flying device; and controlling the movement of the flying device based on at least some of the second signal received and the determined position of the electronic device.

According to various embodiments, the method may further include: receiving the third signal from the electronic device; and performing the photographing by using the camera device in response to the third signal.

According to various embodiments, the controlling of the camera device may include detecting an image signal from a position notification device of the electronic device through the camera device.

According to various embodiments, the image signal may include an optical signal that is generated from least one of a flash LED, or an HRM sensor, of the electronic device.

According to various embodiments, the method may further include: determining the photographing execution timing in response to the third signal; and perform the photographing at the photographing execution timing. According to various embodiments, the method may further include performing the photographing based on photographing information, which is received from the electronic device, such that the photographing information may contain a photographing time or a photographing method.

According to various embodiments, the method may further include delaying the photographing execution to correspond to the photographing execution timing (e.g., the execution timing that is determined based on the photographing time or the photographing method).

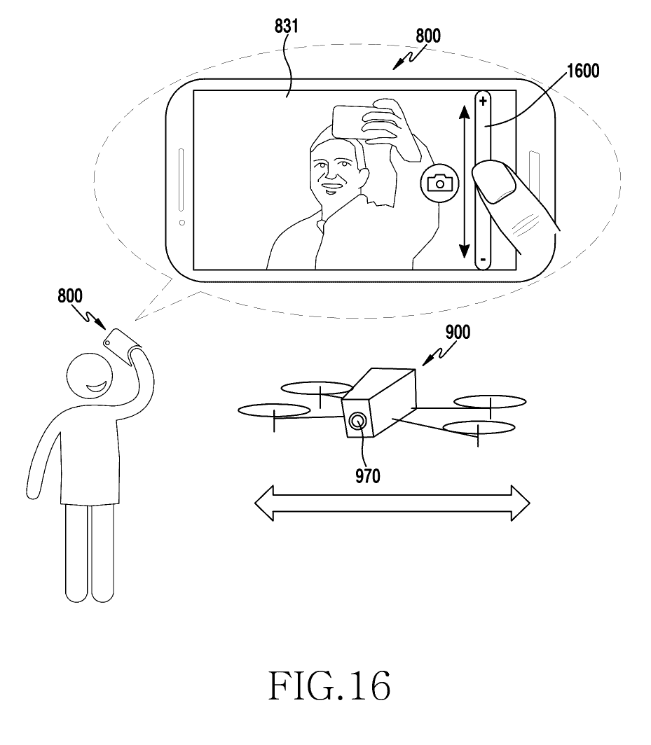

FIG. 16 is a view illustrating an operation example for controlling the flying device in the electronic device, according to various embodiments of the present disclosure.

Referring to FIG. 16, FIG. 16 may illustrate an example of a user interface that is provided through the electronic device 800 in order to adjust the distance between the flying device 900 and the user, and of an operating method thereof. As shown in FIG. 16, according to an embodiment, the electronic device 800 may display, through the display 831, a preview image that is received from the flying device 900. According to an embodiment, the electronic device 800 may provide a control interface 1600 for adjusting the distance (such as, for example, the forward or backward distance relative to the electronic device 800) of the flying device 900 through a portion of the display 831, along with the preview image. For example, the user may select (e.g., touch) the control interface 1600 and may execute an up-and-down input (or make a left-and-right input or a rotation input in another embodiment of the control interface) in order to reduce the distance between the flying device 900 and the user (e.g., control the flying device 900 to move forward towards the electronic device 800), or in order to thereby increase the distance between the flying device 900 and the user (e.g., control of the flying device 900 to move backwards away from the electronic device 800).

According to various embodiments, when a user input is received based on the control interface 1600, the electronic device 800 may create at least some of adjustment information such as position information (e.g., positional coordinate) for controlling movement, distance information for controlling movement (e.g., vertical, left-and-right, or back-and-forth movement distance information), or zoom-in/out information of the camera corresponding to the user input, and may transmit the same to the flying device 900 through the position notification module 600. The flying device 900 may fly to move based on the adjustment information received from the electronic device 800.

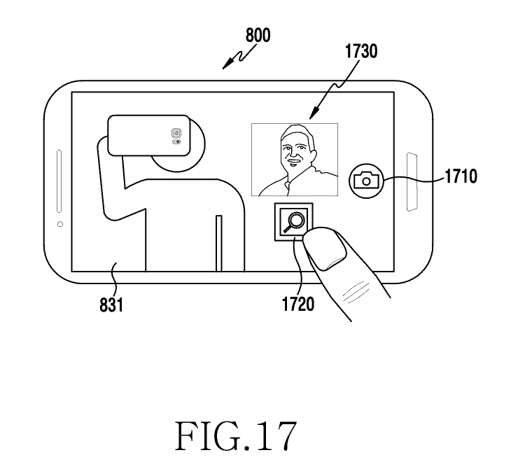

FIG. 17 is a view illustrating diagram showing an operation example for configuring the photographing composition in the electronic device, according to various embodiments of the present disclosure.

According to various embodiments, if the user controls the flying device 900 by holding a selfie pose with the electronic device 800, the camera module 970 of the flying device 900 may provide an actual preview image in which the face of the user is covered by the electronic device 800, as shown in FIG. 17. Therefore, in various embodiments, the photographing is not performed in the state in which the user is viewing the preview image (e.g., before the actual photographing operation is performed), and the intuitiveness of configuring the photographing composition may be improved based on the next operation and the interface.

For example, the user may configure a desired composition while checking the preview image by the flying device 900 through the display 831 of the electronic device 800. At this time, as shown in FIG. 17, the user's face may be invisible because it is covered by the electronic device 800 in the preview image. In this case, the user may want to see the user's face that is actually photographed in the preview image.

Thus, various embodiments may provide a composition checking button 1720 that allows the user to view the user's face, which is actually photographed, in the preview image. According to various embodiments, the composition checking button 1720 is intended to execute a function of displaying the face image of the user, which is actually photographed, through a portion of the preview image, and, for example, may be a button for operating the camera module 870 (in particular, the front camera) of the electronic device 800. In various embodiments, the composition checking button 1720 may be provided in a pre-defined area, or in an area that does not overlap the preview image, on the display 831, or may be provided adjacent to the photographing button 1710. According to various embodiments, the composition checking button 1720 may be replaced with the photographing button 1710.

If the electronic device 800 detects the selection (e.g., a touch) of the composition checking button 1720 while displaying the preview image received from the flying device 900 through the display 831, the electronic device 800 may turn on the front camera that is formed on the front side of the electronic device 800. The electronic device 800 may obtain the user image from the front camera while displaying the preview image, and may display the obtained user image through at least a portion (e.g., the preview area 1730) of the display 831. In various embodiments, the preview area 1730 may be provided in the form of a pop-up window, or may be provided in the form of an overlay on the preview image. In various embodiments, the preview area 1730 may be provided in a pre-defined area, or in an area that does not overlap the preview image, on the display 831. In various embodiments, the input of the composition checking button 1720 to display the user image based on the electronic device 800 may be performed by a touch & release method with respect to the composition checking button 1720, or by a touch & hold method with respect to the composition checking button 1720.

If the electronic device 800 detects a user input for removing the display of the user image from the display 831, the electronic device 800 may remove the preview area 1730 (e.g., remove the display of the user image) from the display 831. In various embodiments, the user input for removing the display of the user image, for example, may be configured based on at least some of the release of the touch that remains on the composition checking button 1720, the re-selection of the composition checking button 1720, or the selection of the photographing button 1710.

According to various embodiments, when a photographing request is received from the user based on the photographing button 1710 (for example, when the photographing button 1710 is selected), the electronic device 800 may transmit a photographing signal to the flying device 900. In various embodiments, the flying device 900 may fix the current flight position in response to the photographing signal. For example, the position of the flying device 900 may be fixed regardless of the movement of the electronic device 800.

According to various embodiments, if the flying device 900 detects a user's motion of lowering the electronic device 800 after receiving the photographing signal, the flying device 900 may automatically perform the photographing. Alternatively, the flying device 900 may delay the photographing (or wait) for a configured specific time (e.g., 3 seconds, 5 seconds, or the like) upon the reception of the photographing signal, and then may automatically perform the photographing.

According to various embodiments, if the electronic device 800 determines the initiation of the photographing operation by the photographing button 1710, the electronic device 800 may provide a countdown audio signal (e.g., a voice signal) corresponding to a specific time (e.g., 3 seconds, 5 seconds, or the like), which is configured with the flying device 900.

In order to solve the problems above, the flying electronic device and the operating method, according to various embodiments, can reduce the inconvenience of the operation of moving the flying device 900 to a desired position and performing the photographing by the user when photographing pictures/moving images by using the flying device (e.g., the drone). Various embodiments may provide a photographing method and an apparatus in which the movement of the flying device (e.g., position translation, hovering, rotation of the drone, or revolution of the drone) can be controlled by using the motion of the user's electronic device (e.g., the smart phone) and the user can perform the photographing through the camera of the flying device by using the electronic device.

Various embodiments may provide a method and an apparatus, in which the photographing of images/moving images by using the flying device and the movement control of the flying device may be intuitively implemented, and even users who are inexperienced at controlling the flying device can easily control the flying device and can perform the photographing of the pictures/moving images in a desired composition, in order to thereby improve the user's convenience.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

The control unit may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

The embodiments of the present disclosure disclosed herein and shown in the drawings are merely specific examples presented in order to easily describe technical details of the present disclosure and to help the understanding of the present disclosure, and are not intended to limit the present disclosure. Therefore, it should be construed that, in addition to the embodiments disclosed herein, all modifications and changes or modified and changed forms derived from the technical idea of the present disclosure fall within the present disclosure.

What is claimed is:

1. An electronic device comprising:
a communication circuit configured to communicatively couple with a flying device including a camera device;
a position notification device for generating an image signal;
one or more sensors configured to detect a motion of the electronic device;
a processor electrically coupled with the communication circuit, the position notification device, and the one or more sensors; and
a memory electrically coupled with the processor, the memory storing instructions that, when executed, cause the processor to:
transmit, using the communication circuit, a first signal to the flying device instructing the flying device to recognize the generated image signal,
generate the image signal via the position notification device,
receive, using the communication circuit, a second signal from the flying device confirming that the flying device recognized the generated image signal, and
transmit, using at least one of the communication circuit and the position notification device, a third signal to the flying device to control movement of the flying device.

2. The device according to claim 1, wherein the instructions further cause the processor to transmit, using the communication circuit, a fourth signal to the flying device instructing the flying device to photograph at least one image using the camera device.

3. The device according to claim 2, wherein the position notification device includes at least one of a flash light emitting diode (LED), an infrared (IR) LED, a heartrate monitor (HRM) sensor, and an ultrasonic sensor.

4. The device according to claim 3, wherein the image signal generated by the position notification device includes a preconfigured pattern.

5. The device according to claim 2, wherein the instructions further cause the processor to:
collect sensor information from the one or more sensors of the electronic device;
determine movement of the electronic device based on the collected sensor information; and
generate the third signal based on the movement of the electronic device and transmit the third signal to the flying device to control the movement of the flying device.

6. A flying device, comprising:
a camera device;
a communication circuit configured to communicate with an electronic device;
one or more sensors configured to detect movement of the flying device;
a processor electrically coupled with the camera device, the communication circuit, and the one or more sensors; and
a memory electrically coupled with the processor, the memory storing instructions that, when executed, cause the processor to:
in response to receiving a first signal from the electronic device using the communication circuit, control the operation of the flying device according to the first signal and control the camera device to detect an image signal generated by the electronic device,
determine a position of the electronic device based on the detected image signal, and
in response to receiving, using the communication circuit, a second signal from the electronic device, control movement of the flying device based on at least a portion of the received second signal and the determined position of the electronic device.

7. The device according to claim 6, wherein the instructions further cause the processor to:
receive a third signal from the electronic device; and
perform photographing using the camera device in response to the received third signal.

8. The device according to claim 7, wherein the image signal is generated by a position notification device of the electronic device.

9. The device according to claim 8, wherein the image signal includes an optical signal generated by at least one of a flash light-emitting diode (LED), and a heartrate monitor (HRM) sensor of the electronic device.

10. The device according to claim 7, wherein the instructions further cause the processor to perform photographing based on photographing information received from the electronic device, the photographing information including at least one of a photographing time and a photographing method.

11. An method for an electronic device, comprising:
transmitting a first signal to a flying device instructing the flying device to recognize an image signal generated by the electronic device;
generating the image signal;
receiving a second signal from the flying device indicating that the flying device recognized the image signal generated by the electronic device based on at least a portion of the image signal; and
transmitting a third signal to the flying device to control movement of the flying device.

12. The method according to claim 11, further comprising transmitting a fourth signal to the flying device instructing the flying device to photograph images using a camera device included in the flying device.

13. The method according to claim 11, wherein the image signal includes a signal output based on at least one of a flash light-emitting diode (LED), an infrared (IR) LED, a heartrate monitor (HRM) sensor, and an ultrasonic sensor of the electronic device, and
wherein the image signal includes a preconfigured pattern.

14. The method according to claim 11, wherein the transmitting of the third signal comprises:
collecting sensor information from one or more sensors of the electronic device;
determining movement of the electronic device based on the collected sensor information; and
transmitting a third signal to the flying device to control movement of the flying device according to the determined movement of the electronic device.

15. An method of a flying device, comprising:
receiving a first signal transmitted from an electronic device;
controlling operations of the flying device in response to the received first signal;
controlling a camera device to detect an image signal generated by the electronic device and determining a position of the electronic device based on the detected image signal; and
in response to receiving a second signal controlling movement of the flying device based on at least a portion of the received second signal and the determined position of the electronic device.

16. The method according to claim 15, further comprising:
receiving a third signal from the electronic device; and
performing photographing using the camera device in response to the received third signal.

17. The method according to claim 15, wherein the image signal is generated from a position notification device of the electronic device.

18. The method according to claim 15, wherein the image signal includes an optical signal generated from least one of a flash light-emitting diode (LED) and a heartrate monitor (HRM) sensor of the electronic device.

19. The method according to claim 16, further comprising performing the photographing based on photographing information received from the electronic device, wherein the photographing information includes at least one of a photographing time and a photographing method.

20. The method according to claim 19, further comprising delaying execution of the photographing according to the photographing time or the photographing method.
